(19) United States
(12) Patent Application Publication
(10) Pub. No.: US 2017/0339542 A1
(43) Pub. Date: Nov. 23, 2017

(54) EMERGENCY OR OTHER SERVICE RAPID LOCATION HUB, REQUEST METHOD AND/OR DATA SHARING INTERFACE

(71) Applicant: Alfredo Bocanegra, Sylmar, CA (US)

(72) Inventor: Alfredo Bocanegra, Sylmar, CA (US)

(21) Appl. No.: 15/169,303

(22) Filed: May 31, 2016

Related U.S. Application Data
(60) Provisional application No. 62/168,548, filed on May 29, 2015.

(51) Int. Cl. H04W 4/22; H04W 4/02; H04M 1/725

(52) U.S. Cl. CPC H04W 4/22; H04M 1/72536; H04W 4/023

(57) ABSTRACT

A software or interface or method is disclosed for allowing requests for emergency or other services to be made by a user. The software or method may be related to a mobile (e.g., cell phone) application and can improve identification of a user or associated information to request services (e.g., emergency services and/or other convenience services) at a particular location.

### CROSS REFERENCE TO RELATED APPLICATIONS

This application claims the benefit of U.S. Provisional Patent Application Ser. No. 62/168,548, filed on May 29, 2015, entitled “EMERGENCY OR OTHER SERVICE RAPID LOCATION HUB, REQUEST METHOD AND/OR DATA SHARING INTERFACE,” which is hereby incorporated by reference in its entirety.

### BACKGROUND

### 1. Field of the Invention

The present invention relates to a set of processes implemented via software, new interfaces, and/or paradigm shifts, which allows requests for emergency or other services to be made faster and/or with more relevant information by a user. More particularly, the present invention relates to mobile or other software applications that improve a user's identification and/or to request services, for example, at a specified location or for a specified circumstance.

### 2. Description of the Related Art

A single point of contact emergency interface between a user and a service provider (e.g., such as 9-1-1 for police departments, fire departments, etc.) have existed for many years in the United States and other countries that allow individuals to personally dial a number and speak with an emergency services operator to report an issue. As a result of operator's trained questioning, the user or caller will communicate the following to the operator: (1) the issue they are having, (2) the location where assistance is required, and (3) whether anyone is in danger of losing their life. The operator then manually enters the information into a computer, determines the closest service provider to the user, and dispatches the appropriate personnel and/or resources. In some instances, the location may be directly obtained due to the known location of the telephone the caller used to originate the reporting. Originally developed in a time when landline telephones were conventionally used, this emergency request procedure and infrastructure has become increasingly outdated, especially with the advent of mobile devices such as smartphones that may be carried with users and thus not static at a particular geographic location.

Other problems exist with this emergency reporting procedure. Abuse by callers of 9-1-1 from anonymous individuals (e.g., use of a payphone, pre-paid cell phone, or other public phone) can result in emergency personnel being directed to a location where no emergency assistance is needed. Moreover, misuse of 9-1-1 (e.g., calling of 9-1-1 for services that are better remedied by non-emergency personnel like locksmiths, animal control, etc.) clogs the emergency service call lines, resulting in emergencies not receiving ideal response. In addition, for an emergency within public view, multiple 9-1-1 calls about the same incident may be made, when only the first call is necessary to direct the appropriate personnel to the area. There is also no (or limited availability or use) secondary form of communication (other than direct phone line), available for reporting or requesting emergency assistance. Thus, there is a need for an improved method and/or apparatus for dealing with emergencies and/or other services desired by users. Ideally, such a method and/or apparatus would be particularly useful for users with portable electronic devices, such as smart phones, and would help eliminate or reduce the problems previously described for the conventional emergency services reporting or requesting procedure.

### SUMMARY

The present invention is related to a method and/or application and/or system for allowing requests for emergency or other services by a user. For example, such requests may be in the form of or include information relating to (1) location identification, (2) submissions of reports, and/or (3) data transmission via an interface (such as via a mobile device software application). An improved method may be based upon Internet Protocol and/or interfaces with a user, in contrast to conventional systems that only go as far as to provide support down to an operator. In one embodiment, a method of providing service request functionality to a user, the method including the steps of providing a mobile application configured to be executed by a processor of a mobile device, determining, using the processor, a type of service desired by the user, determining, using the processor, a geographic position of the mobile device, determining, using the processor, an appropriate service provider to service the type of service desired by the user based on the geographic position of the mobile device, interfacing, using the processor, with a system associated with the service provider, and communicating to the user, using the processor, that the service provider will be servicing the type of service desired by the user.

In another embodiment, a mobile application for a service request functionality for a user may include computer-readable instructions configured to be executed by a processor of a mobile device, the instructions configured to determine, using the processor, a type of service desired by the user, determine, using the processor, a geographic position of the mobile device, interface, using the processor, with a system associated with the service provider, and communicate to the user, using the processor, that the service provider will be servicing the type of service desired by the user.

### BRIEF DESCRIPTION OF THE DRAWINGS

The features, objects, and advantages of the present invention will become more apparent from the detailed description set forth below when taken in conjunction with the drawings, wherein:

FIG. 1A shows a mobile application for having service request functionality according to one embodiment of the present invention;

FIG. 1B shows the mobile application of FIG. 1A with a 9-1-1 interface according to one embodiment of the present invention;

FIG. 1C shows a block diagram of a system implementing a service request software application according to one embodiment of the present invention;

FIG. 2 shows a flowchart of location based identification for a software application having service request functionality according to one embodiment of the present invention;

FIG. 3 shows a flowchart of a medical interface for a software application having service request functionality according to one embodiment of the present invention;

FIG. 4 shows a flowchart of wearable functionality for a software application having service request functionality according to one embodiment of the present invention;

FIG. 5 shows a flowchart of a police interface for a software application having service request functionality according to one embodiment of the present invention;

FIG. 6 shows a flowchart of a situational assessment for police service requests for a software application having service request functionality according to one embodiment of the present invention;

FIG. 7 shows a flowchart of a situational assessment for police service requests for a software application having service request functionality according to one embodiment of the present invention;

FIG. 8 shows a flowchart of a fire service request for a software application having service request functionality according to one embodiment of the present invention;

FIG. 9 shows a flowchart of a fire service request for a software application having service request functionality according to one embodiment of the present invention;

FIG. 10 shows a flowchart of animal control service requests for a software application having service request functionality according to one embodiment of the present invention;

FIG. 11 shows a flowchart of towing service requests for a software application having service request functionality according to one embodiment of the present invention;

FIG. 12 shows a flowchart of mechanic service requests for a software application having service request functionality according to one embodiment of the present invention;

FIG. 13 shows a flowchart of locksmith service requests for a software application having service request functionality according to one embodiment of the present invention;

FIG. 14 shows display screens of locksmith service requests for a safe for a software application having service request functionality according to one embodiment of the present invention;

FIG. 15 shows display screens of locksmith service requests for a door for a software application having service request functionality according to one embodiment of the present invention;

FIG. 16 shows display screens of locksmith service requests for an automobile for a software application having service request functionality according to one embodiment of the present invention;

FIG. 17 shows display screens of locksmith service requests for a residence for a software application having service request functionality according to one embodiment of the present invention;

FIG. 18 shows a flowchart of insurance service requests for a software application having service request functionality according to one embodiment of the present invention;

FIG. 19 shows a flowchart of insurance service requests for a software application having service request functionality according to one embodiment of the present invention;

FIG. 20 shows a flowchart of insurance service requests for a software application having service request functionality according to one embodiment of the present invention;

FIG. 21 shows a flowchart of insurance service requests for a software application having service request functionality according to one embodiment of the present invention;

FIG. 22 shows a flowchart of insurance service requests for a software application having service request functionality according to one embodiment of the present invention;

FIG. 23 shows a flowchart of insurance service requests for a software application having service request functionality according to one embodiment of the present invention;

FIG. 24 shows a flowchart of insurance service requests for a software application having service request functionality according to one embodiment of the present invention;

FIG. 25 shows a flowchart of insurance service requests for a software application having service request functionality according to one embodiment of the present invention;

FIG. 26 shows a process flow of insurance service requests for a software application having service request functionality according to one embodiment of the present invention;

FIG. 27 shows a process flow for “In Case of Emergency” requests for a software application having service request functionality according to one embodiment of the present invention; and

FIG. 28 shows a flowchart of “In Case of Emergency” requests for a software application having service request functionality according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

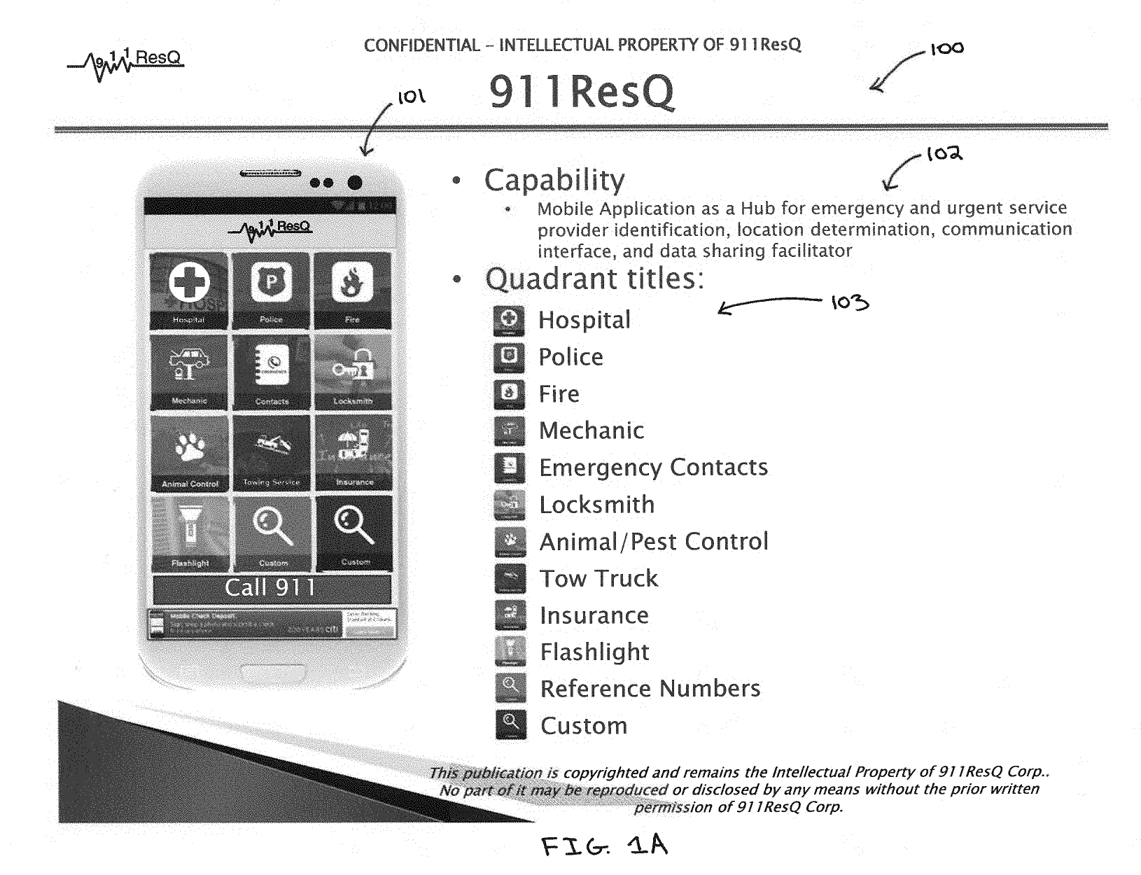

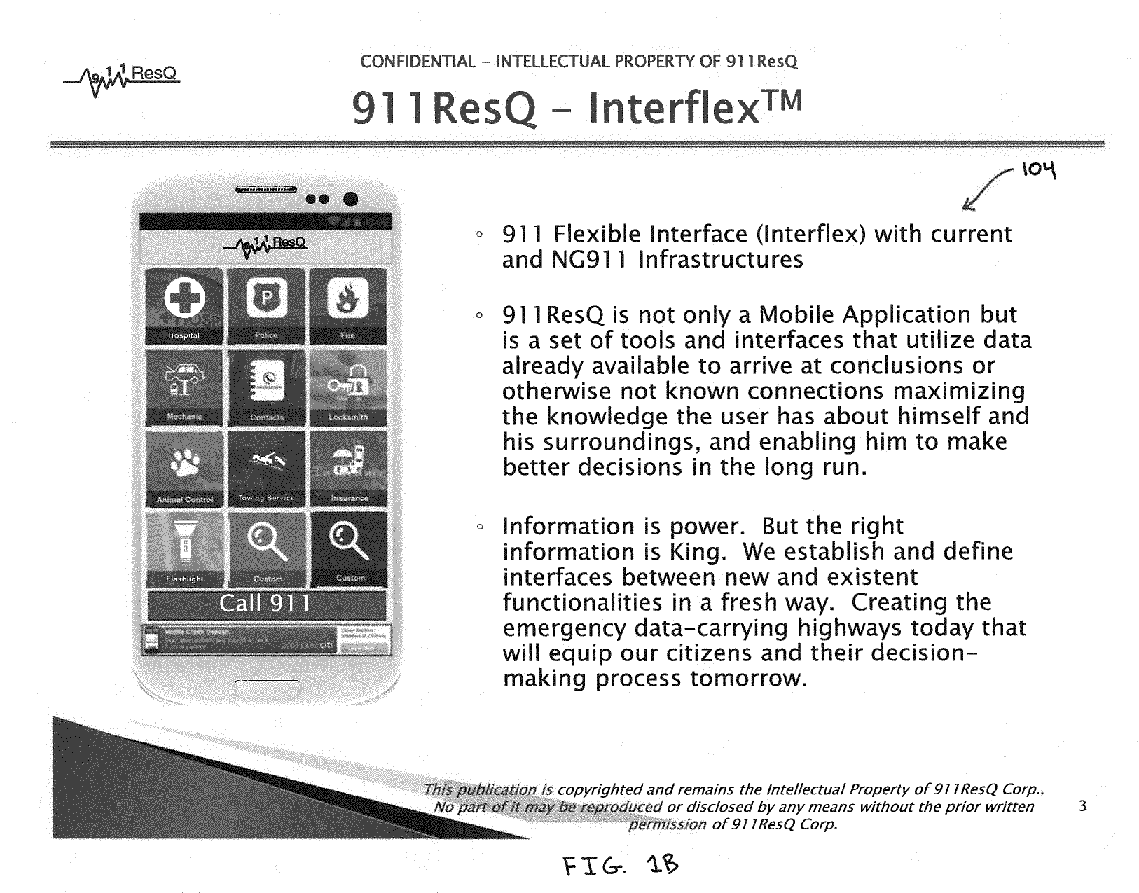

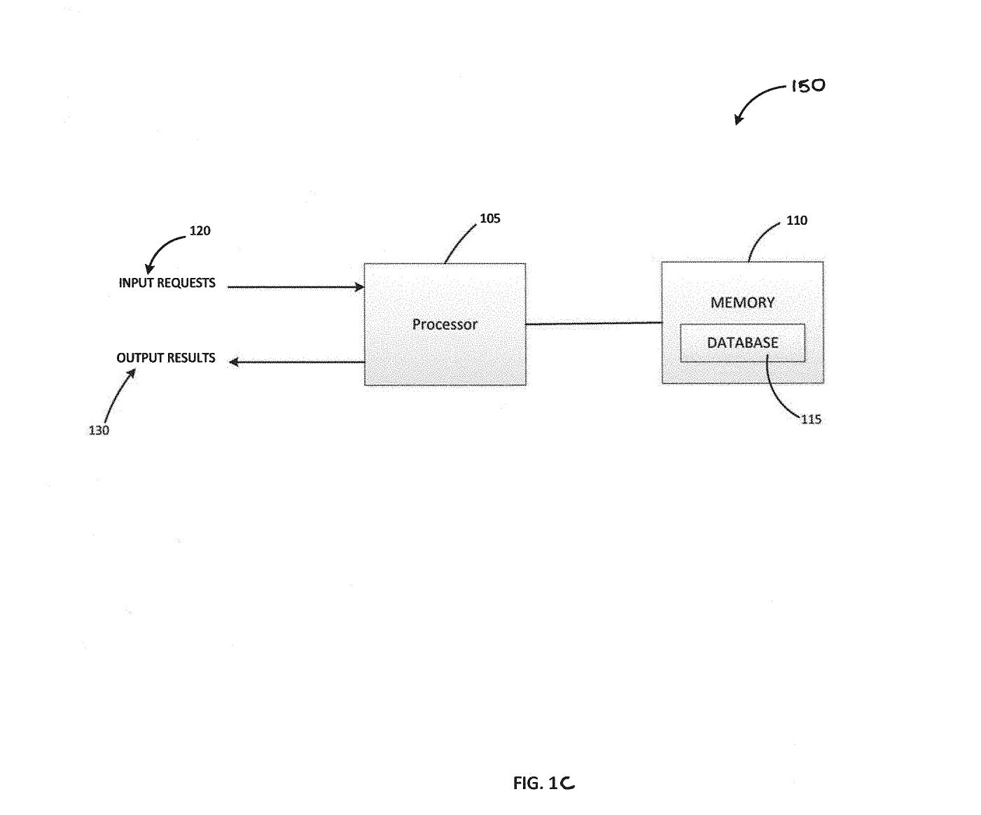

Turning first to FIG. 1A, a mobile application 100 is shown having service request functionality. For example, a mobile device, such as a cell phone, smartphone, tablet, etc. may be configured to run a software application or executable such that a plurality of possible service requests are displayed 101 upon a display or screen of the mobile device. Thus, a user in need of one or more of the services may be permitted to choose one or more of the services and subsequently request a service to be rendered. The mobile application 100 may act as a hub 102 for emergency, urgent service, and/or other service provider identification, location determination, communication interface, and/or data sharing functionality, among other possible features. For example, any or all of the following services 103 may be permitted on the mobile application 100: hospital, police, fire, mechanic, emergency contacts, locksmith, animal/pest control, tow truck, insurance, flashlight, and/or reference numbers. A user may also be permitted to enter and/or save custom services as part of the mobile application 100. Embodiments of several of these possible services 103 are described in greater detail herein.

FIG. 1B shows the mobile application 100, previously discussed for FIG. 1A, but further identifies an exemplary interface 104 with emergency and/or urgent services, such as 9-1-1 (e.g., NG911 infrastructures). For example, the mobile application 100 may include features that extend beyond a listing of emergency or other service requests contacts, but be incorporated into the systems, databases, etc. of service providers so that users of the mobile application 100 can communicate or interface directly with the provider's system without being required, for example, to call or communicate with a live personnel of the service provider that must then manually enter information regarding the call or communication into the system. This may save time and/or expense and may allow responders of a service provider more efficiently act to resolve a user's request.

FIG. 1C shows a block diagram of a system 150 implementing a service request software application. For example, the software application having service request functionality may include features that are the same as or similar to those previously discussed. The system 150 includes a processor 105 connected with a memory 110, the memory 110 configured to store data. The processor is configured to interface or otherwise communicate with the memory, for example, via electrical signals propagated along a conductive trace or wire. In an alternative embodiment, the processor 105 may interface with the memory 110 via a wireless connection. In one embodiment, the memory 110 may include a database 115, a plurality of data or entries capable of being stored in the database 115 of the memory 110.

As discussed in greater detail herein, the processor 105 may be tasked with executing software or other logical instructions in order for the service request application to function as desired. Input requests 120 may be received by the processor 105 (e.g., via signals transmitted from a user at a remote system or device, such as a handheld device like a smartphone or tablet, to the processor 105 via a network or Internet connection). In an alternative embodiment, the input requests 120 may be received by the processor via a user input device that is not at a geographically remote location (e.g., via a connected keyboard, mouse, etc. at a local computer terminal). After performing tasks or instructions based upon the user input requests 120, for example, looking up information or data stored in the memory 110, the processor 105 may output results 130 back to the user that are based upon the input requests 120.

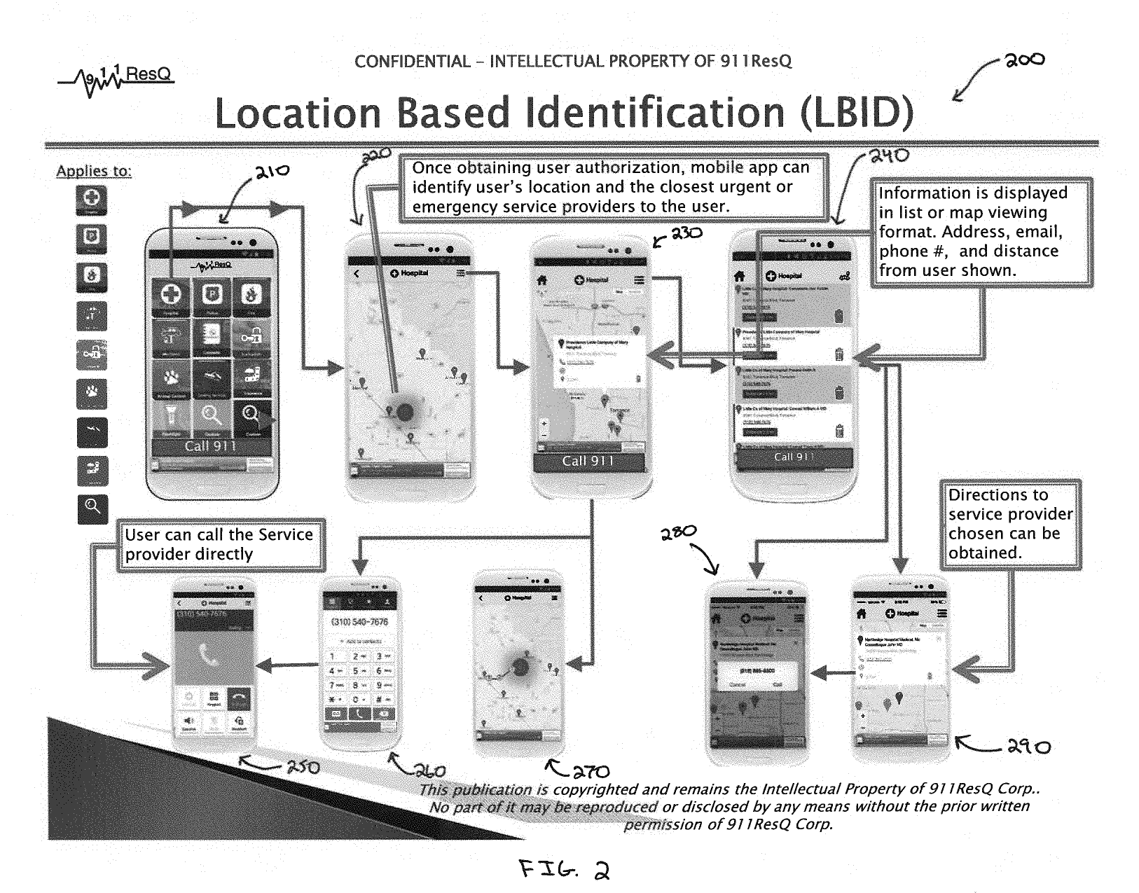

FIG. 2 shows a flowchart 200 of location based identification for a software application having service request functionality. For example, the software application having service request functionality may include features that are the same as or similar to those previously discussed. Location based identification may allow for automatic identification of the location of a user that is requesting service, rather than requiring a user to manually state or otherwise enter in the location where services are desired.

At step 210, a user may load up the software application and press (e.g., using their finger) or otherwise interface with the software to select a type of service that is desired. Any of a variety of possible service requests may be part of the software application (e.g., hospital, police, fire, mechanic, locksmith, animal control, towing, insurance, custom-made or user defined, etc.). Once obtaining user authorization (e.g., a pop-up box or as part of an agreement, such as a EULA or other agreed-to term when installing and/or setting up the software application), the mobile application may determine a current or other desired location 220 for the user and populate a map or other display of corresponding (e.g., nearby) services 230 that match with the user's desired service.

For example, upon clicking one or more of the corresponding services, additional information 240, such as address, email, phone number, distance, etc. may be conveyed to the user (e.g., shown in either a pop-up view, list view for multiple services, or other format). In some embodiments, the user may then click on one or more of the additional information 240 to perform an additional action with such service provider (e.g., call 250-280 the service provider and/or get directions 290 to the service provider. In some embodiments, a “Call 9-1-1” or other such direct-communication element may be displayed (e.g., always displayed) in the software application so that a user can always elect to immediately attempt connection with an emergency service

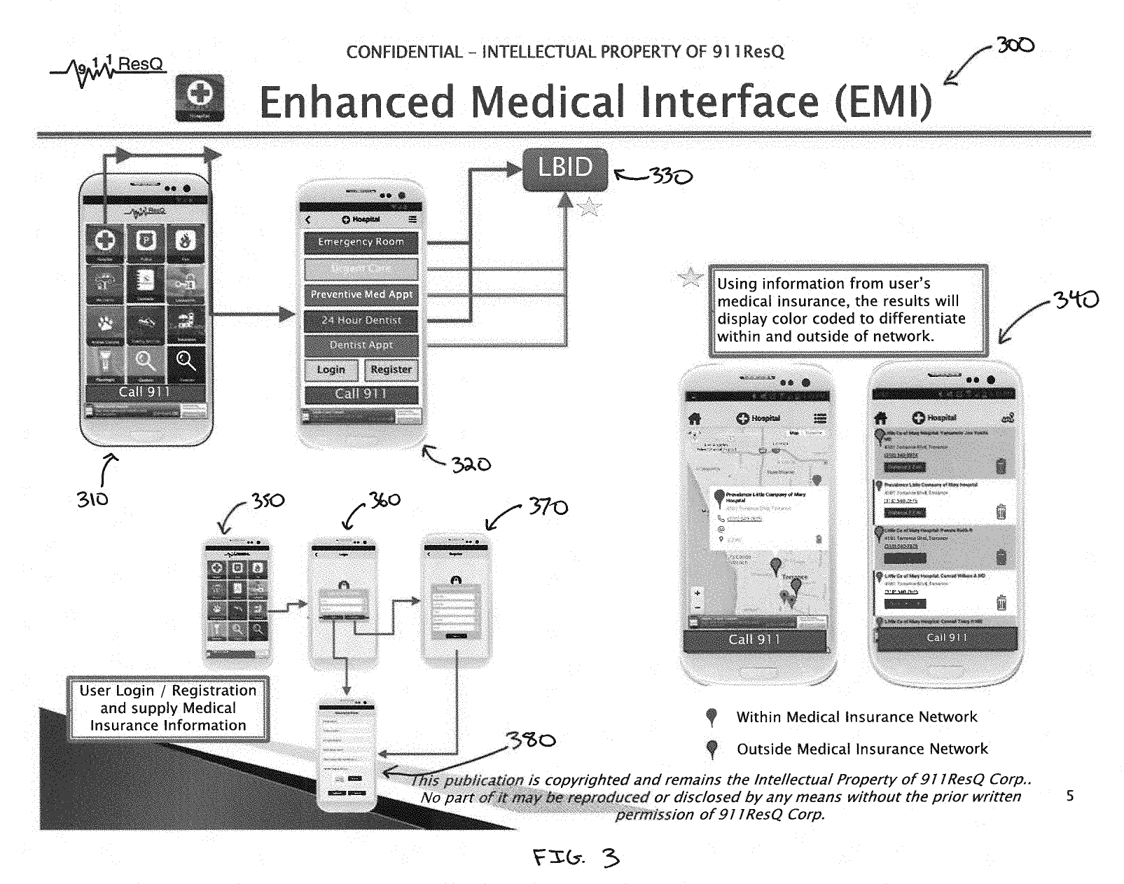

FIG. 3 shows a flowchart 300 of a medical interface for a software application having service request functionality. For example, the software application having service request functionality may include features that are the same as or similar to those previously discussed. At step 310, a user may load up the software application and press (e.g., using their finger) or otherwise interface with the software to select a type of service that is desired. As illustrated, a user may press upon a “Hospital” or similar designation to request medical service. A display 320 of possible medical requests may then subsequently be displayed to the user. For example, one or more of these possible requests may be emergency room, urgent care, preventative medical appointments, 24-hour dentist care, dental appointments, etc. As discussed above, location based identification (“LBID”) 330 may operate as part of the medical service request or interface. For example, using information from a user's medical insurance, discussed in greater detail below, results for possible medical service requests 340 may be determined and/or displayed (e.g., using color coding or other format) to differentiate between inside/outside medical insurance networks or other criteria.

As shown in steps 350, 360, 370, and 380, a user may register with the software application (and subsequently “login” on future uses of the software login after a successful registration, medical insurance information for the user. This may include, among various possibilities, the type of medical insurance plan the user has coverage under. Thus, as mentioned above for results for possible medical service requests 340, this insurance information may be used to display appropriate information to the user in making more informed choices for a desired medical service request. In one example, a user may be able to sort, display, or otherwise differentiate between service providers, doctors, etc. that are covered by their medical insurance.

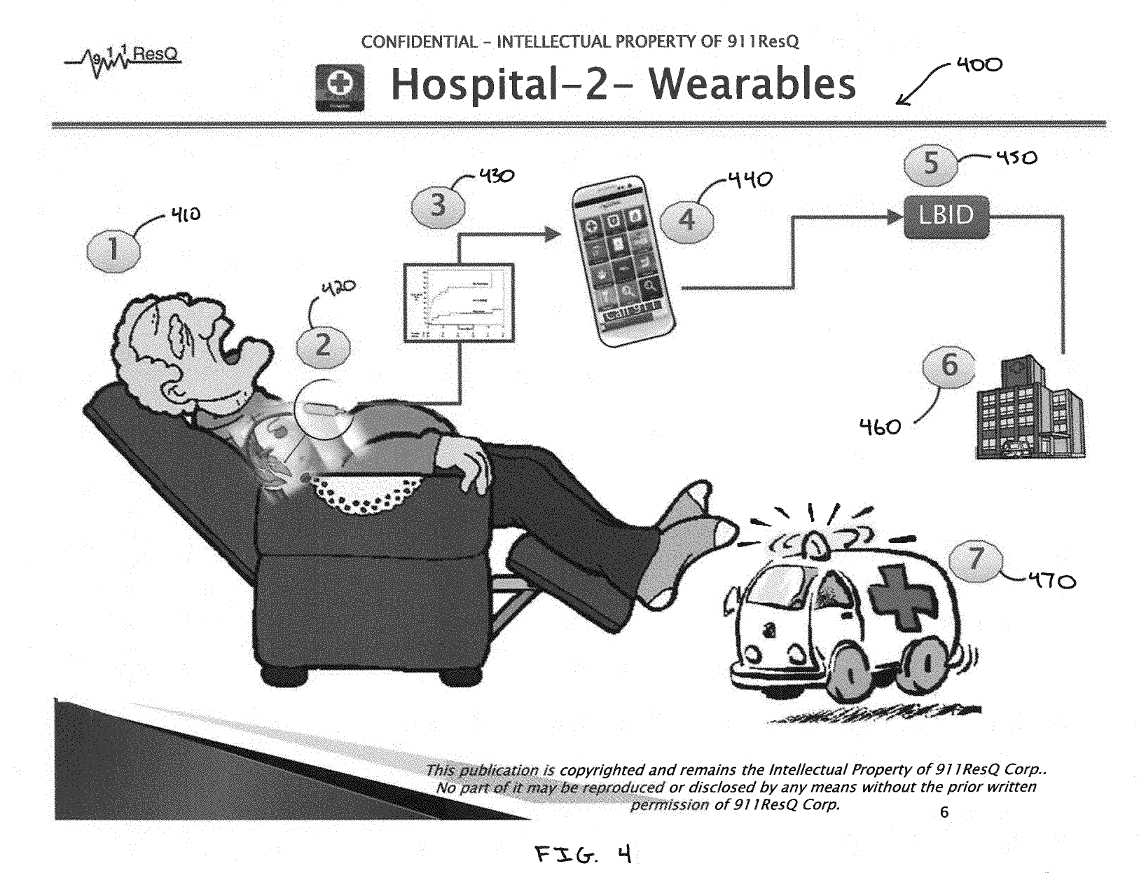

FIG. 4 shows a flowchart 400 of wearable functionality for a software application having service request functionality. For example, the software application having service request functionality may include features that are the same as or similar to those previously discussed. At step 410, an individual is sleeping, resting, or otherwise living while undergoes some type of medical issue or emergency (e.g., a heart attack). At step 420, a medical device that is implanted within the individual or otherwise connected or interfacing with the individual, the medical device communicates with the software application through any of a variety of communication protocols (e.g., Bluetooth, Wi-Fi, etc.). For example, data or statistics about the individual and/or the medical device (e.g., an anomaly in heart rate rhythm) may be communicated to the software application.

At step 430, the software application analyzes the data or statistics received in order to confirm or determine whether those data or statistics require or would benefit from emergency, medical, or other services from a service provider. If so, at step 440, the software application locates the nearest or most appropriate service provider (e.g., using location based identification as discussed above or any of a variety of other methods, such as availability of personnel, etc.). At step 450, some or all of the data or statistics may be communicated from the software application to the appropriate service provider determined in step 440.

At step 460, the service provider responds by sending the appropriate personnel and/or equipment and/or other service (e.g., an electric signal), such as an ambulance. At step 470, the individual receives the transmitted or dispatched service from the service provider. A same or similar procedure can be used for any of a variety of medical, and/or other service needs. For example, diabetes insulin pumps, blood pressure sensors, pain pumps (e.g., for dispersing morphine to chronic pain patients), helmets or other equipment for sports to detect head trauma or other bodily injury, servicemen/women experiencing explosions or other wartime or training that surpasses a predetermined threshold (e.g., G forces to a helmet that may cause concussion), motorcycle helmets, etc.

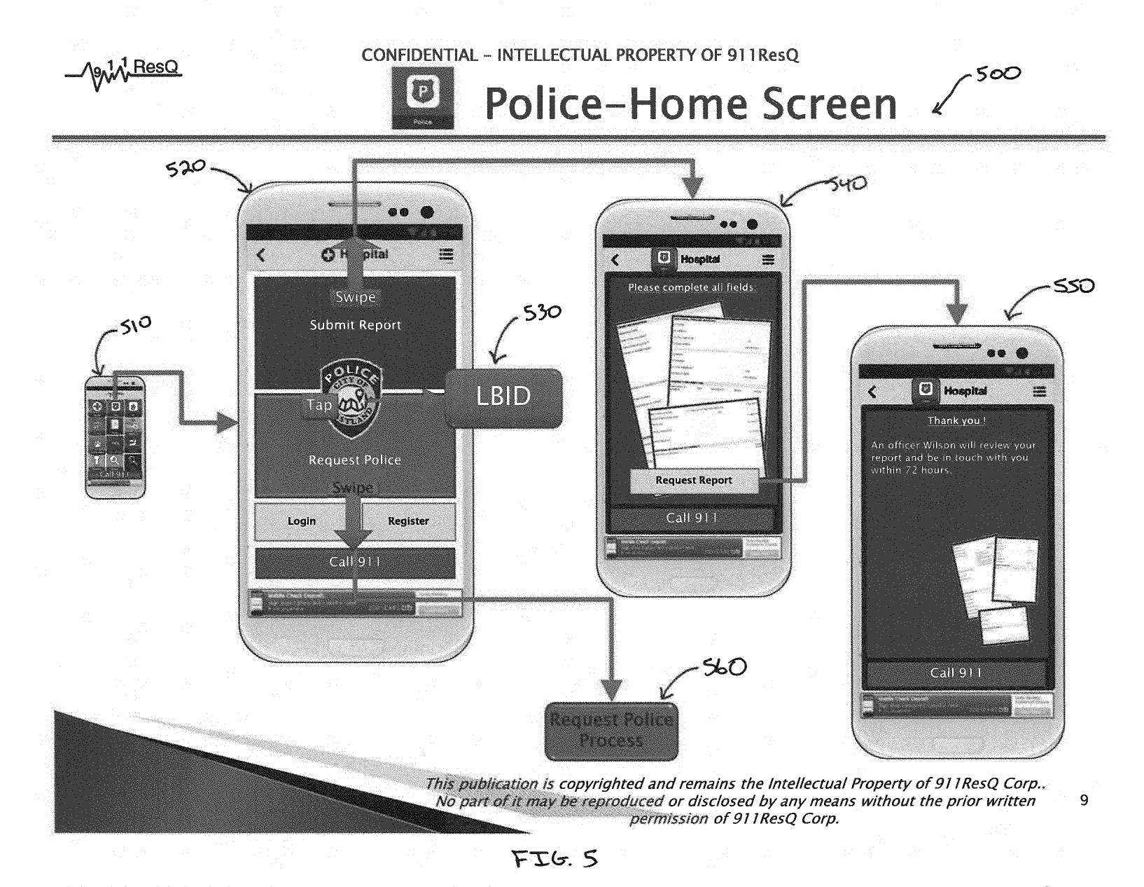

Turning next to FIG. 5, a flowchart 500 of a police interface is shown for a software application having service request functionality. For example, the software application having service request functionality may include features that are the same as or similar to those previously discussed. At step 510, a user may load up the software application and press (e.g., using their finger) or otherwise interface with the software to select a type of service that is desired, here illustrated as the police interface. Upon selection, at step 520, the police interface is displayed. Although a variety of possible interfaces may be used in alternative embodiments, as shown, a user of the police interface may be allowed to tap on the display in order to obtain a nearby, local, or otherwise appropriate police communication contact 530 (e.g., phone number), for example, using location-based identification that is the same as or similar to the previous discussions. A user may also be permitted to swipe upwards in order to fill out or complete a police report 540. Upon completion of some or all of the fields presented to the user for filling in or entering of information, a user may press a request report or similar user-interface element to submit 550 the report to an appropriate police or law enforcement department. A user may also be permitted to swipe downwards in order to request police presence 560.

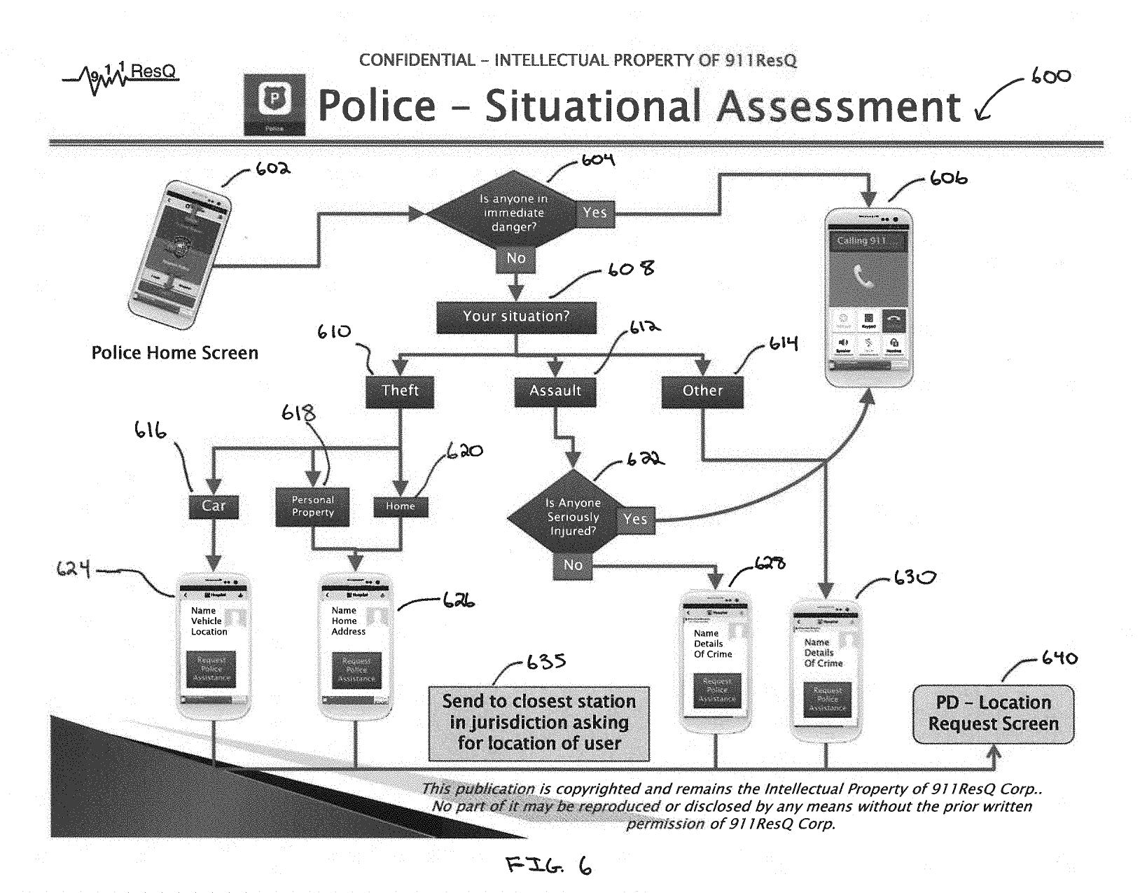

FIG. 6 shows a flowchart 600 of a situational assessment for police service requests (e.g., step 560 of FIG. 5) for a software application having service request functionality. For example, the software application having service request functionality may include features that are the same as or similar to those previously discussed. At step 602, the software application may permit a user to request police or law enforcement presence. Upon such a user request using the software application, a series of clarifying questions and/or steps may be taken to aid in the efficient resolution of the user's issue.

At step 604, the user is asked whether anyone is in immediate danger. If the user replies with a Yes response, operation continues to step 606 where the user may be put in contact with emergency services personnel or representatives (e.g., 9-1-1) to further describe the situation and/or needed personnel. However, if the user replies with a No response, the user is prompted with a request 608 for the type of situation. A variety of types may be provided to the user for selection, for example, theft 610, assault 612, or Other 614. If the user replies with a theft response, the user may be further asked what type of theft, with possible types being Car 616, Personal Property 618, or Home 620. If the user replies with a car response, the user may be prompted for their name and/or the vehicles last known location and/or other information and a request for police assistance communicated 635 to a nearest or most appropriate station (e.g., within the jurisdiction for the location of the user, for example, using location based identification as discussed or with a further screen 640 asking the user for location details). However, if the user replies with a personal property or home response, the user may be prompted for their name and/or the home address for the user and a request for police assistance communicated 635, the same or similar as previously mentioned.

Turning back to step 608, if the user replies with an assault response, the user may be asked if anyone was seriously injured. If the user replies with a Yes response, operation may continue to step 606, the same or similar as previously mentioned. However, if the user replies with a No response, the user may be prompted for their name and/or additional crime details and a request for police assistance communicated 635, the same or similar as previously mentioned. Likewise, turning back to step 608, is the user replies with an other response, the user may be prompted for their name and/or additional crime details and a request for police assistance communicated 635, the same or similar as previously mentioned.

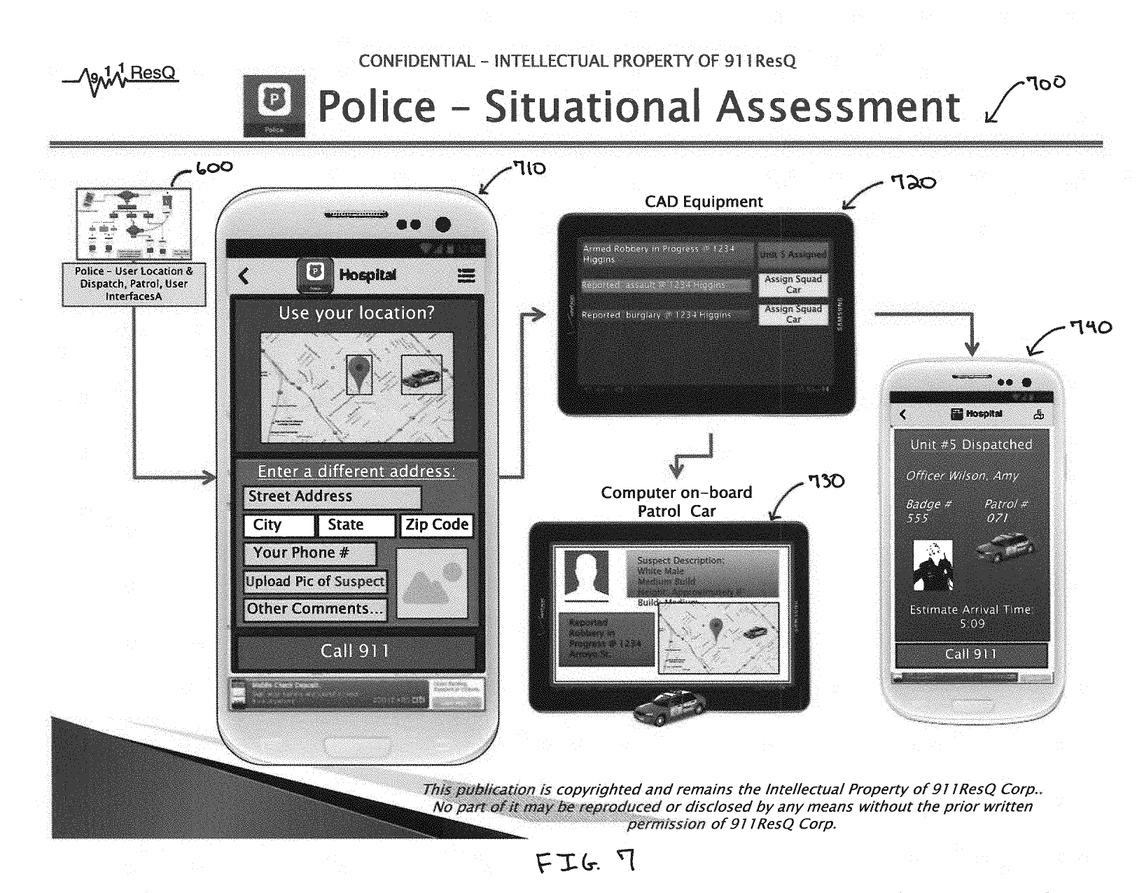

FIG. 7 shows a flowchart 700 of a situational assessment for police service requests (e.g., step 640 of FIG. 5) for a software application having service request functionality. For example, the software application having service request functionality may include features that are the same as or similar to those previously discussed. The process or steps of flowchart 700 may be performed after one or more process steps shown in flowchart 600, previously discussed for FIG. 6. At step 710, a screen may be displayed to a user to aid in determining a location for the user. This screen may include automatic location-based identification (e.g., using GPS) such that the location of the user via their mobile device is determined automatically by the software application. The screen may also or alternatively allow the user to manually enter a desired address. At step 720, this location information is sent to equipment of the appropriate police or law enforcement department (e.g., as discussed for FIG. 6) that a representative or employee of such department may use to efficiently deploy desired personnel to handle the situation. This may include dispatch of a police officer with a subsequent confirmation screen 740 of such dispatch to the user of the software application. Likewise, a computer on-board the dispatched patrol car may be transmitted information about the police request such that a display 730 in the patrol car is updated to include such information.

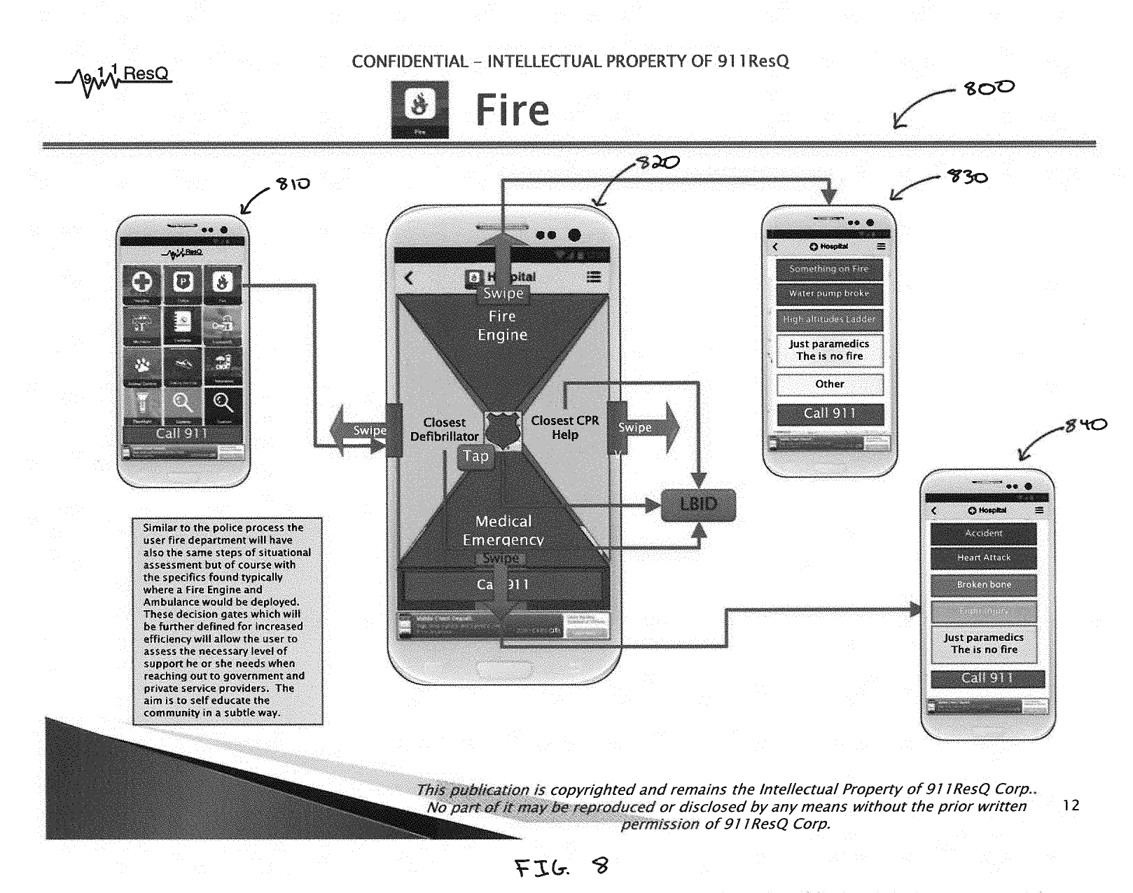

FIG. 8 shows a flowchart 800 of a fire service request for a software application having service request functionality. For example, the software application having service request functionality may include features that are the same as or similar to those previously discussed. At step 810, a user of the software application may interface or select a service desired, illustrated in FIG. 8 for fire. The same or similar to previous discussions, at step 820, the user may tap and/or perform swipe actions on the displayed screen in order to request assistance for different situations. As shown, a user may tap the screen to obtain contact information (e.g., a telephone number) for the closest or most appropriate fire department, as previously discussed using the concept of LBID. Likewise, a user may swipe to the right to utilize the concept of LBID to determine the closest facility and/or apparatus to aid in CPR of an individual. A user may also swipe left to utilize the concept of LBID to determine the closest facility and/or apparatus to aid in defibrillating an individual.

As shown in step 830, a user may swipe up in order to request the services of a fire engine, a subsequent screen being displayed to the user for allowing the user to indicate what service(s) are required. Possible options for the user to choose amongst may be: (1) something on fire, (2) water pump broken, (3) high altitude ladder needed, (4) paramedics needed without any fire, and/or (5) other type of service is required. Turning back to step 820, a user may also swipe downwards to display a screen 840 regarding a request for aid due to a medical emergency. Possible options for the user to choose amongst for the medical emergency may be: (1) accident, (2) heart attack, (3) broken bone(s), (4) fight injury, and (5) other or general paramedics needed without any fire. In an alternative embodiment, any of a variety of additional or alternative options may be shown and/or selectable by a user.

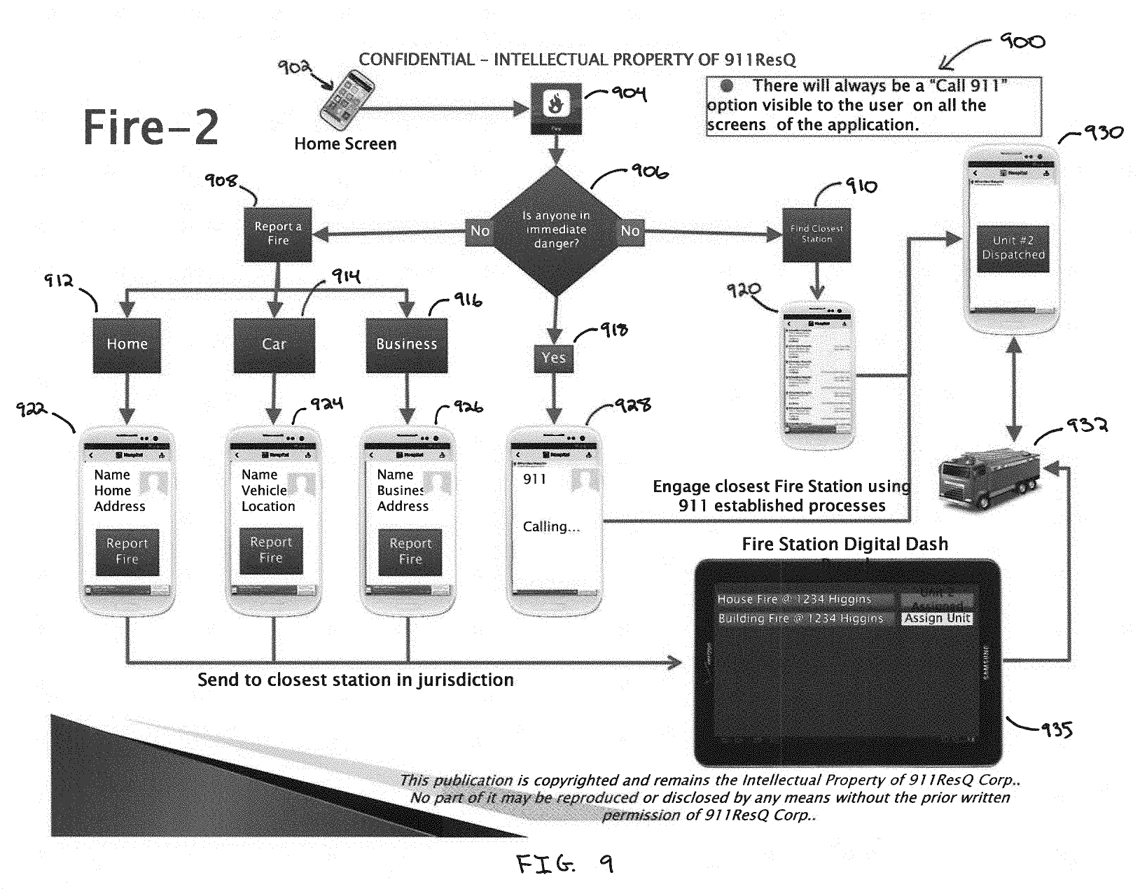

FIG. 9 shows a flowchart 900 of one possible process or software flow for a software application allowing a user to request services due to a medical issue or emergency (e.g., step 840 of FIG. 8, previously discussed). For example, the software application having service request functionality may include features that are the same as or similar to those previously discussed. As shown, at step 902 a user of a software application may interface with the software application and at step 904 select or choose fire department services. At step 906, the software application requests the user to answer whether anyone is in immediate danger.

If the user provides a No response, the software may prompt the user to choose whether they wish to report a fire or find a closest fire station. If the user chooses to report a fire at step 908, a number of choices that the user may select amongst may be displayed. For example, those choices may be Home 912, Car 914, and/or Business 916. If the user selects Home 912, the software application may prompt the user to enter or confirm their name and the Home Address at step 922. This information is then sent to the nearest or most appropriate fire station, for example, one having jurisdiction where the home address is located. Similarly, if the user selects Car 914, the software application may prompt the user to enter or confirm their name and the Vehicle Location at step 924. This information is then sent to the nearest or most appropriate fire station as previously discussed. Likewise, if the user selects Business 916, the software application may prompt the user to enter or confirm their name and the Business Address at step 926. This information is then sent to the nearest or most appropriate fire station as previously discussed.

This information may be transmitted and/or displayed at step 935 at an electronic system and/or computer at the fire station providing the requested service, which uses such data or information to determine an appropriate emergency vehicle, personnel, and/or equipment to dispatch at step 932. This vehicle, personnel, and/or equipment is then dispatched to the desired location and a confirmation as such is transmitted to the user at step 930. Returning back to step 906, if the user provides a No response and chooses to find a closest fire station at step 910, a listing of nearest or most appropriate fire stations may be displayed to the user at step 920. However, if the user provides a Yes response at step 906, the software application may dial 9-1-1 or otherwise contact an emergency service, for example, a closest or most appropriate fire station at step 928. After both steps 928 and/or 920, a confirmation of dispatch of a vehicle, personnel, and/or equipment suitable for the situation may be sent to the user so that the user is aware that aid is on the way.

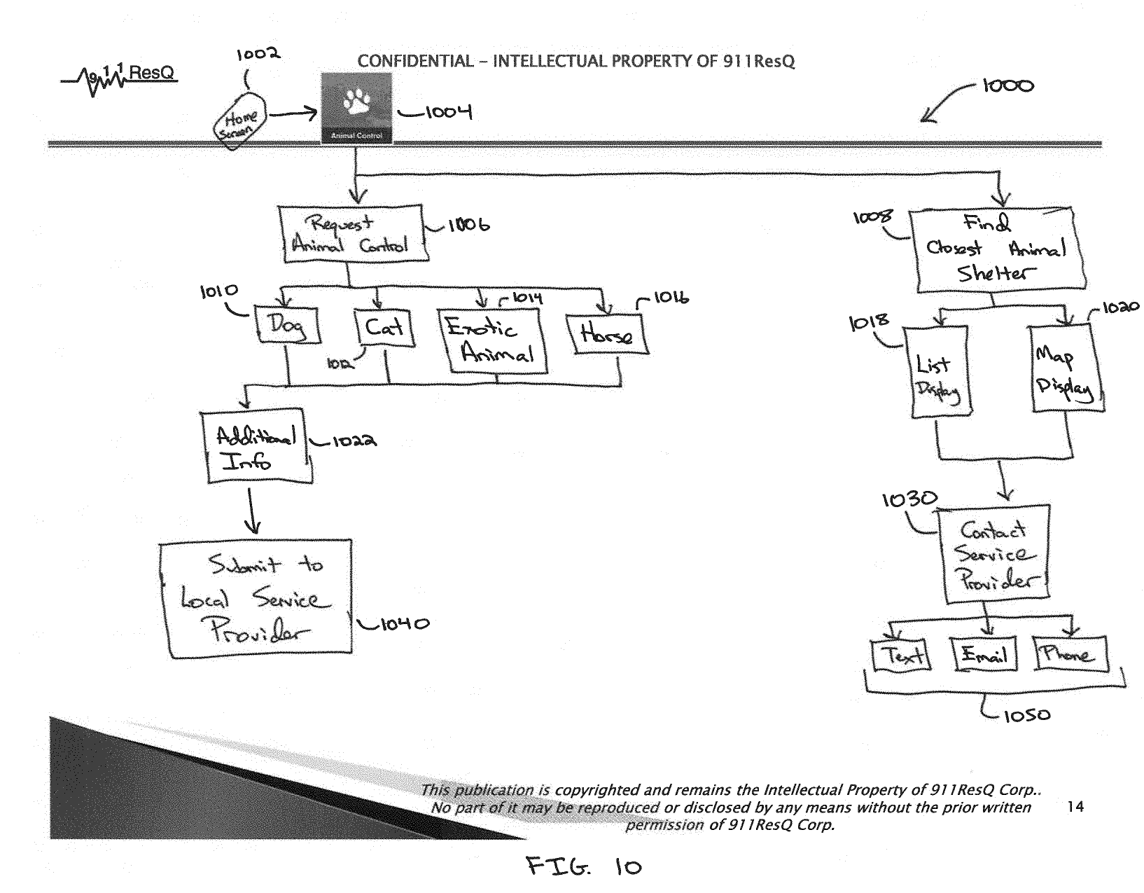

FIG. 10 shows a flowchart 1000 of animal control service requests for a software application having service request functionality. For example, the software application having service request functionality may include features that are the same as or similar to those previously discussed. As shown, at step 1002 a user of a software application may interface with the software application and at step 1004 select or choose animal control services. The user may then select or choose to request animal control services at step 1006 or choose to find the closest animal shelter at step 1008. If the user chooses to request animal control services via step 1006, the user may be further prompted to identify the type of animal for which the service request is regarding. For example, possible animal type options may be Dog 1010, Cat 1012, Exotic Animal (e.g., snake, komodo dragon, etc.) 1014, Horse 1016, etc. Any of a variety of animals and/or animal types may be chosen amongst by the user in an alternative embodiment, such as farm animals, etc. After choosing the animal type, at step 1022, the software application may requests the user to provide any additional information or notes about the animal and/or the situation for which they are requesting service. Operation then continues to step 1040 where some or all of the above information is conveyed to the nearest or most appropriate service provider for handling of the situation. Determination of the nearest or most appropriate service provider may be performed using the same or similar methods as previously discussed (e.g., LBID, manual entry by user, etc.).

Turning back to step 1008, if the user instead opted for information regarding the closest or most appropriate animal shelter, the software application may provide a display screen to the user containing such information. For example, as shown, a list display 1018 and/or a map display 1020 may be provided to the user that identifies one or more appropriate animal shelters that are determined (e.g., as previously discussed) to be most appropriate for the user. The user may then be permitted to choose one or more of the displayed animal shelters and contact the provider of animal shelter services at step 1030. If a shelter has more than one form of communication, the user may be permitted to choose the type of communication (e.g., Text, Email, and/or Phone 1050) that is most desired.

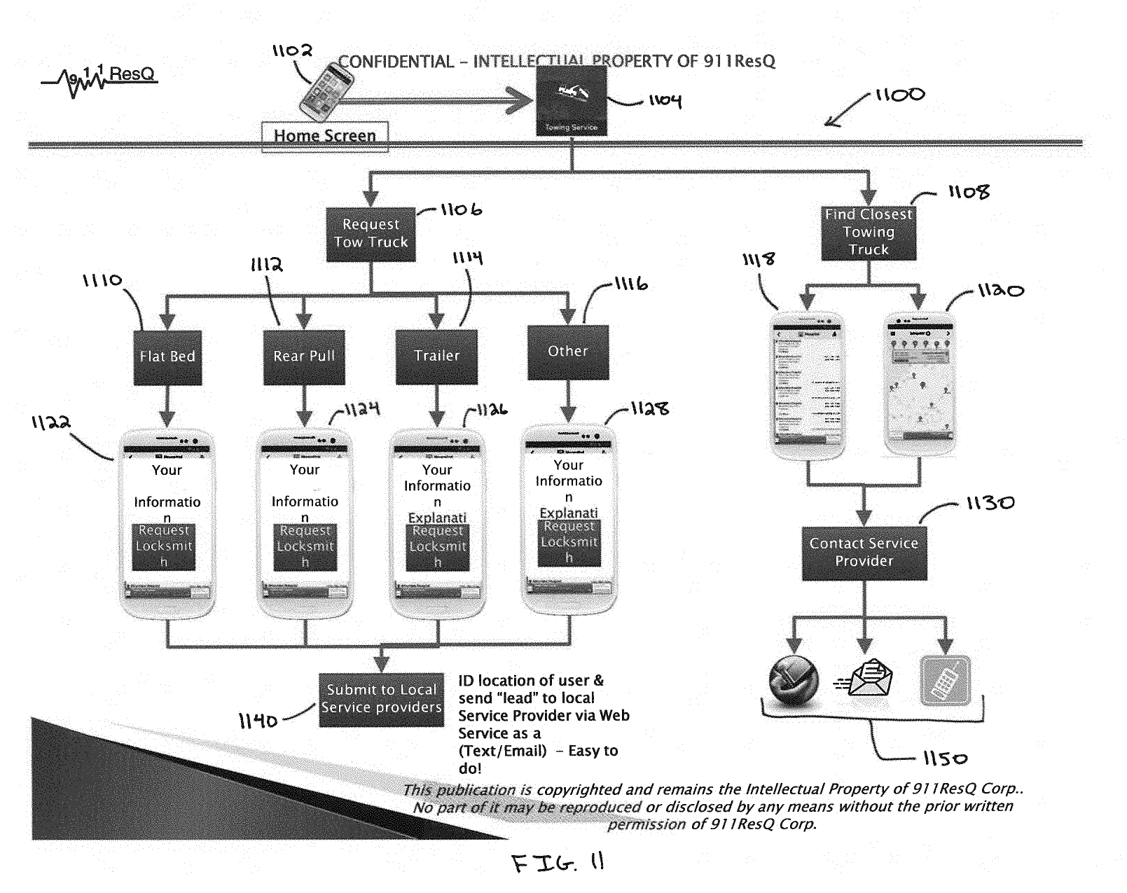

FIG. 11 shows a flowchart 1100 of towing service requests for a software application having service request functionality. For example, the software application having service request functionality may include features that are the same as or similar to those previously discussed. As shown, at step 1102 a user of a software application may interface with the software application and at step 1104 select or choose towing services. The user may then select or choose to request a tow truck at step 1106 or choose to find the closest towing truck at step 1108. If the user chooses to request a tow truck via step 1106, the user may be further prompted to identify the type of vehicle or object for which the tow truck service request is regarding. For example, possible vehicle or object type options may be Flat Bed 1110, Real Pull 1112, Trailer 1114, Other 1116, etc. Any of a variety of vehicles and/or other object types may be chosen amongst by the user in an alternative embodiment, such as farm equipment, industrial equipment, etc. After choosing the vehicle or object type, at steps 1122-1128, the software application may requests the user to provide any additional information or notes about the vehicle, object and/or the situation for which they are requesting tow truck service. Operation then continues to step 1140 where some or all of the above information is conveyed to the nearest or most appropriate service provider for handling of the situation. Determination of the nearest or most appropriate service provider may be performed using the same or similar methods as previously discussed (e.g., LBID, manual entry by user, etc.).

Turning back to step 1108, if the user instead opted for information regarding the closest or most appropriate towing truck, the software application may provide a display screen to the user containing such information. For example, as shown, a list display 1118 and/or a map display 1120 may be provided to the user that identifies one or more appropriate towing trucks that are determined (e.g., as previously discussed) to be most appropriate for the user. The user may then be permitted to choose one or more of the displayed towing truck service providers and contact the provider of the towing services at step 1130. If a service provider has more than one form of communication, the user may be permitted to choose the type of communication (e.g., Text, Email, and/or Phone 1150) that is most desired.

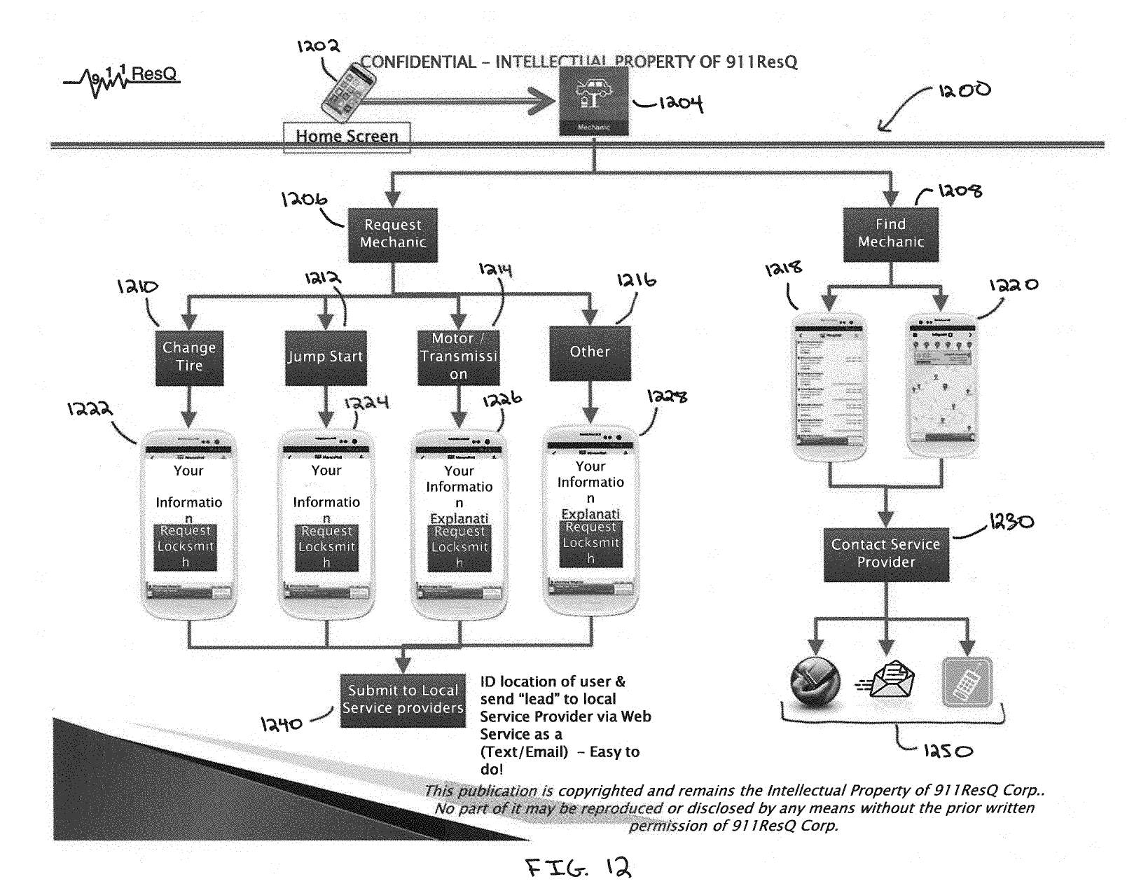

FIG. 12 shows a flowchart 1200 of mechanic service requests for a software application having service request functionality. For example, the software application having service request functionality may include features that are the same as or similar to those previously discussed. As shown, at step 1202 a user of a software application may interface with the software application and at step 1204 select or choose mechanic services. The user may then select or choose to request mechanic services at step 1206 or choose to find the closest or most appropriate mechanic at step 1208. If the user chooses to request mechanic services via step 1206, the user may be further prompted to identify the type of service for which the mechanic is desired. For example, possible service type options may be Changing a Tire 1210, Jump Starting a Vehicle 1212, Motor and/or Transmission Issues 1214, Other Issues 1216, etc. Any of a variety of service types may be chosen amongst by the user in an alternative embodiment, etc. After choosing the service type, at steps 1222-1228, the software application may requests the user to provide any additional information or notes about the vehicle and/or the situation for which they are requesting service. Operation then continues to step 1240 where some or all of the above information is conveyed to the nearest or most appropriate service provider for handling of the situation. Determination of the nearest or most appropriate service provider may be performed using the same or similar methods as previously discussed (e.g., LBID, manual entry by user, etc.).

Turning back to step 1208, if the user instead opted for information regarding the closest or most appropriate mechanic, the software application may provide a display screen to the user containing such information. For example, as shown, a list display 1218 and/or a map display 1220 may be provided to the user that identifies one or more appropriate mechanic service providers that are determined (e.g., as previously discussed) to be most appropriate for the user. The user may then be permitted to choose one or more of the displayed service providers and contact the provider of mechanic services at step 1230. If a mechanic service provider has more than one form of communication, the user may be permitted to choose the type of communication (e.g., Text, Email, and/or Phone 1250) that is most desired.

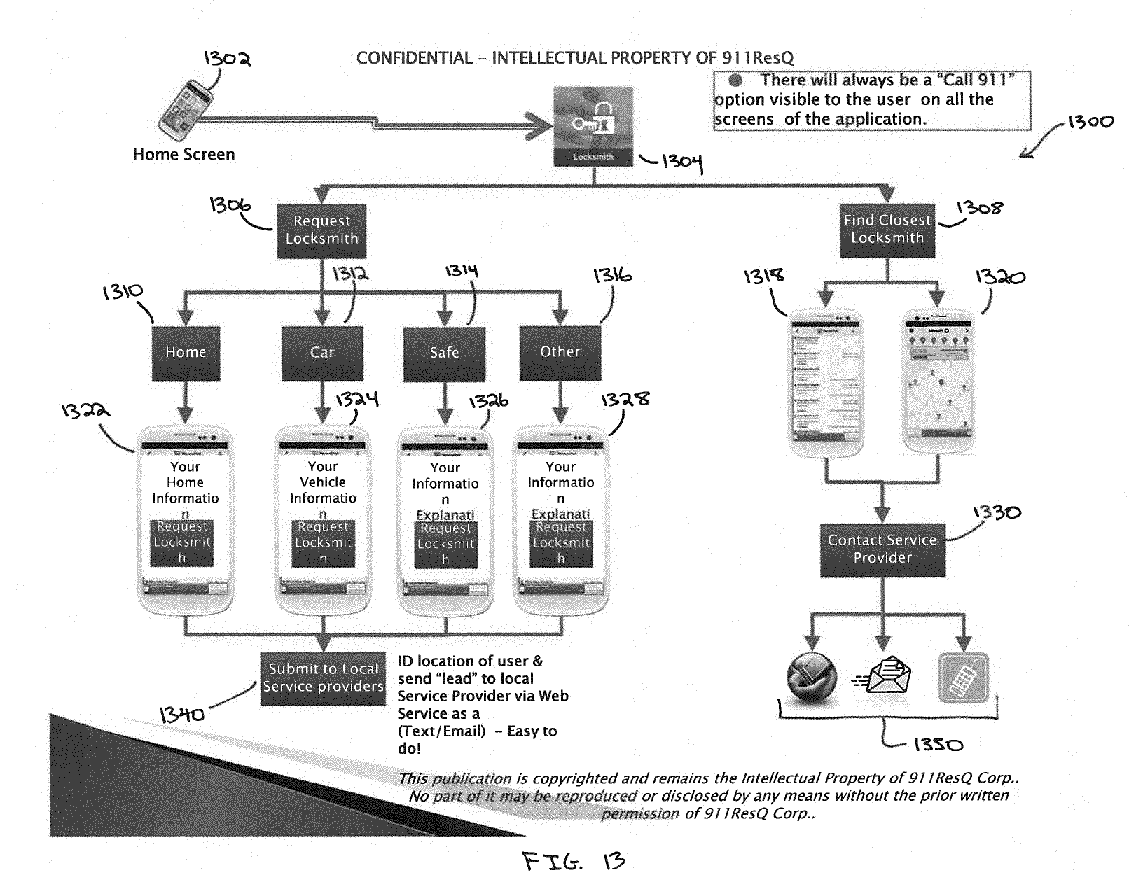

FIG. 13 shows a flowchart 1300 of locksmith service requests for a software application having service request functionality. For example, the software application having service request functionality may include features that are the same as or similar to those previously discussed. As shown, at step 1302 a user of a software application may interface with the software application and at step 1304 select or choose locksmith services. The user may then select or choose to request locksmith services at step 1306 or choose to find the closest locksmith at step 1308. If the user chooses to request locksmith services via step 1306, the user may be further prompted to identify the type of object for which the service request is regarding. For example, possible object type options may be Home 1310, Car 1312, Safe 1314, Other 1316, etc. Any of a variety of objects and/or object types may be chosen amongst by the user in an alternative embodiment, etc. After choosing the object type, at steps 1322-1328, the software application may requests the user to provide any additional information or notes about the object and/or the situation for which they are requesting service. Operation then continues to step 1340 where some or all of the above information is conveyed to the nearest or most appropriate service provider for handling of the situation. Determination of the nearest or most appropriate service provider may be performed using the same or similar methods as previously discussed (e.g., LBID, manual entry by user, etc.).

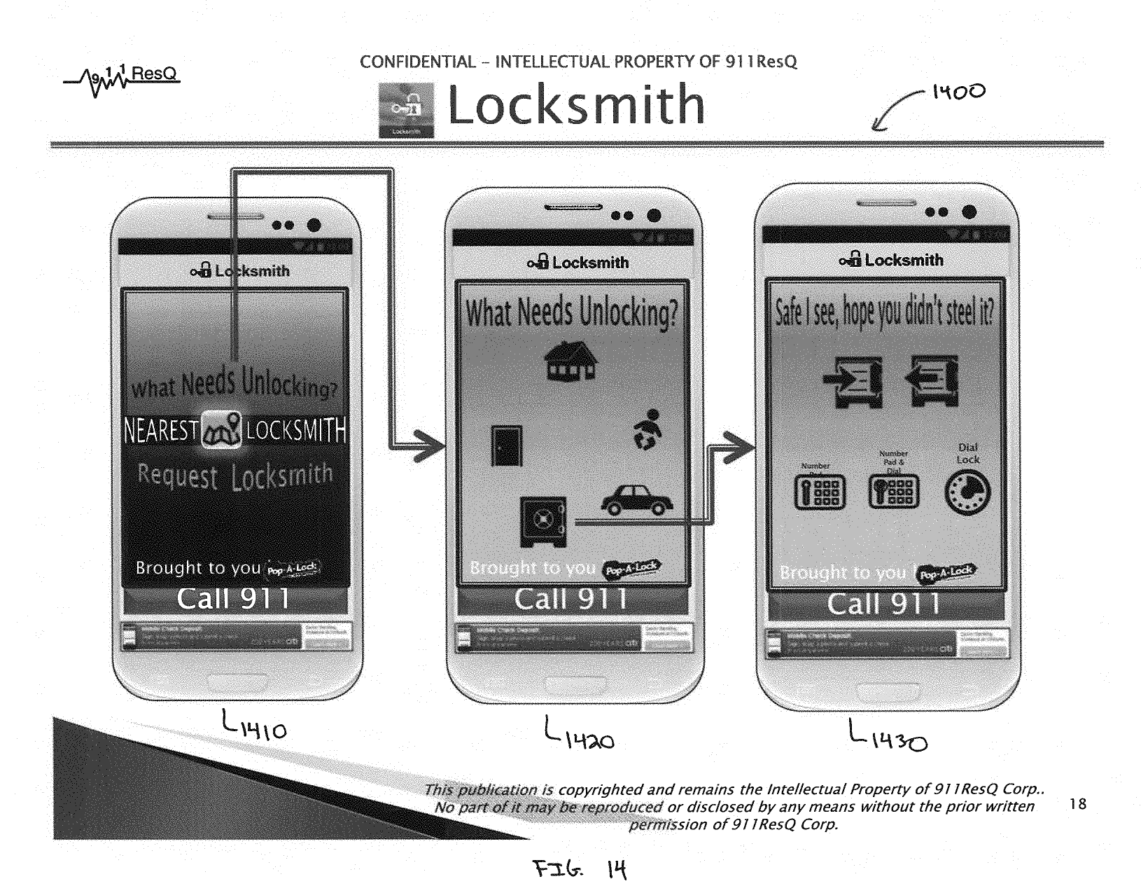

Turning back to step 1308, if the user instead opted for information regarding the closest or most appropriate locksmith service provider, the software application may provide a display screen to the user containing such information. For example, as shown, a list display 1318 and/or a map display 1320 may be provided to the user that identifies one or more appropriate locksmith service providers that are determined (e.g., as previously discussed) to be most appropriate for the user. The user may then be permitted to choose one or more of the displayed locksmith service providers and contact the provider of locksmith services at step 1330. If a locksmith service provider has more than one form of communication, the user may be permitted to choose the type of communication (e.g., Text, Email, and/or Phone 1350) that is most desired. FIGS. 14-17 illustrate a variety of example display screens for requesting various locksmith services and may work in conjunction or relation with one or more steps discussed above for FIG. 13.

FIG. 14 shows display screens 1400 of locksmith service requests for a safe for a software application having service request functionality. For example, the software application having service request functionality may include features that are the same as or similar to those previously discussed. As shown, at step 1410, a display of shown that allows a user to provide details regarding the services desired for a locksmith to help ensure the proper locksmith and/or proper tools are brought by the locksmith to aid the user. For example, upon requesting the services of a locksmith by interfacing with the screen at step 1410, at step 1420, a display is shown to the user with possible equipment that the user desires to have unlocked. In the example shown, at step 1420, the user has selected a safe. Operation then continues to step 1430 where the user is finally prompted for additional information regarding the safe, namely whether it is a number pad safe, a number pad and dial safe, or a dial-lock safe. In an alternative embodiment, additional and/or alternative options may be available for user selection or manipulation

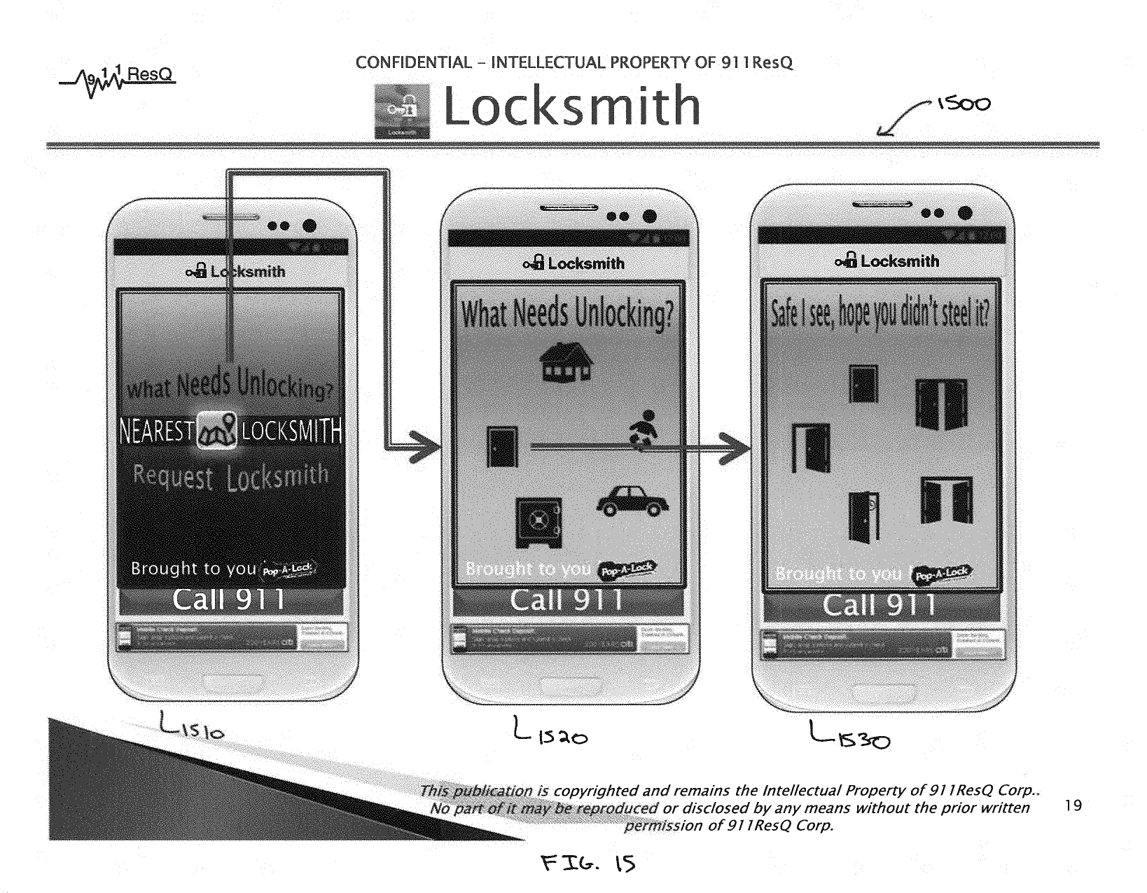

FIG. 15 shows display screens 1500 of locksmith service requests for a door for a software application having service request functionality. For example, the software application having service request functionality may include features that are the same as or similar to those previously discussed. As shown, at step 1510, a display of shown that allows a user to provide details regarding the services desired for a locksmith to help ensure the proper locksmith and/or proper tools are brought by the locksmith to aid the user. For example, upon requesting the services of a locksmith by interfacing with the screen at step 1510, at step 1520, a display is shown to the user with possible equipment that the user desires to have unlocked. In the example shown, at step 1520, the user has selected a door. Operation then continues to step 1530 where the user is finally prompted for additional information regarding the door, namely whether it is a single interior door, a double interior door, a single exterior door, a double exterior door, or any of a variety of other possible door configurations. In an alternative embodiment, additional and/or alternative options may be available for user selection or manipulation.

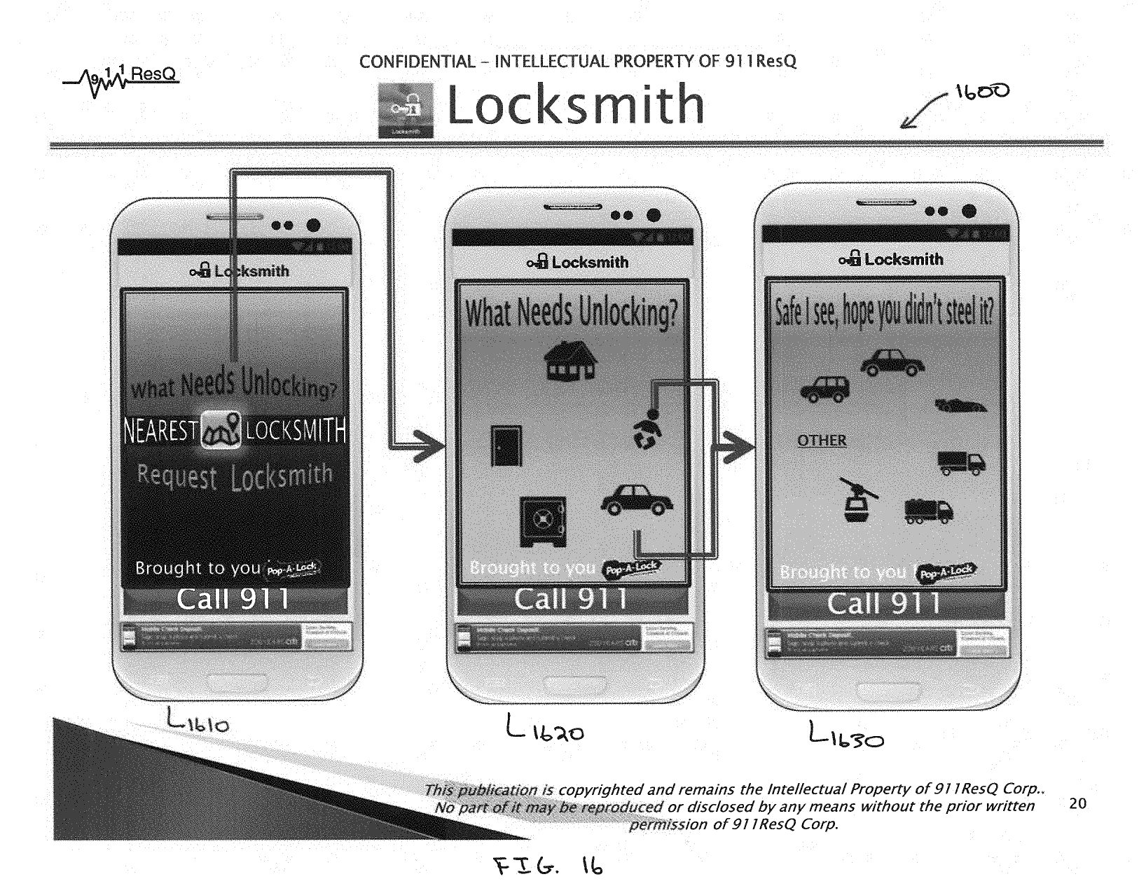

FIG. 16 shows display screens 1600 of locksmith service requests for an automobile for a software application having service request functionality. For example, the software application having service request functionality may include features that are the same as or similar to those previously discussed. As shown, at step 1610, a display of shown that allows a user to provide details regarding the services desired for a locksmith to help ensure the proper locksmith and/or proper tools are brought by the locksmith to aid the user. For example, upon requesting the services of a locksmith by interfacing with the screen at step 1610, at step 1620, a display is shown to the user with possible equipment that the user desires to have unlocked. In the example shown, at step 1620, the user has selected a vehicle and/or has indicated that a baby or toddler has been locked inside of an object. Operation then continues to step 1630 where the user is finally prompted for additional information regarding the vehicle or situation that requires the services, namely whether the vehicle is a consumer automobile/truck/SUV (e.g., the year, brand, and/or model), a race vehicle (e.g., the year, brand, and/or model), a commercial vehicle (e.g., the year, brand, and/or model), an industrial vehicle (e.g., the year, brand, and/or model), or other type of vehicle (e.g., a plane, helicopter, etc.). In an alternative embodiment, additional and/or alternative options may be available for user selection or manipulation.

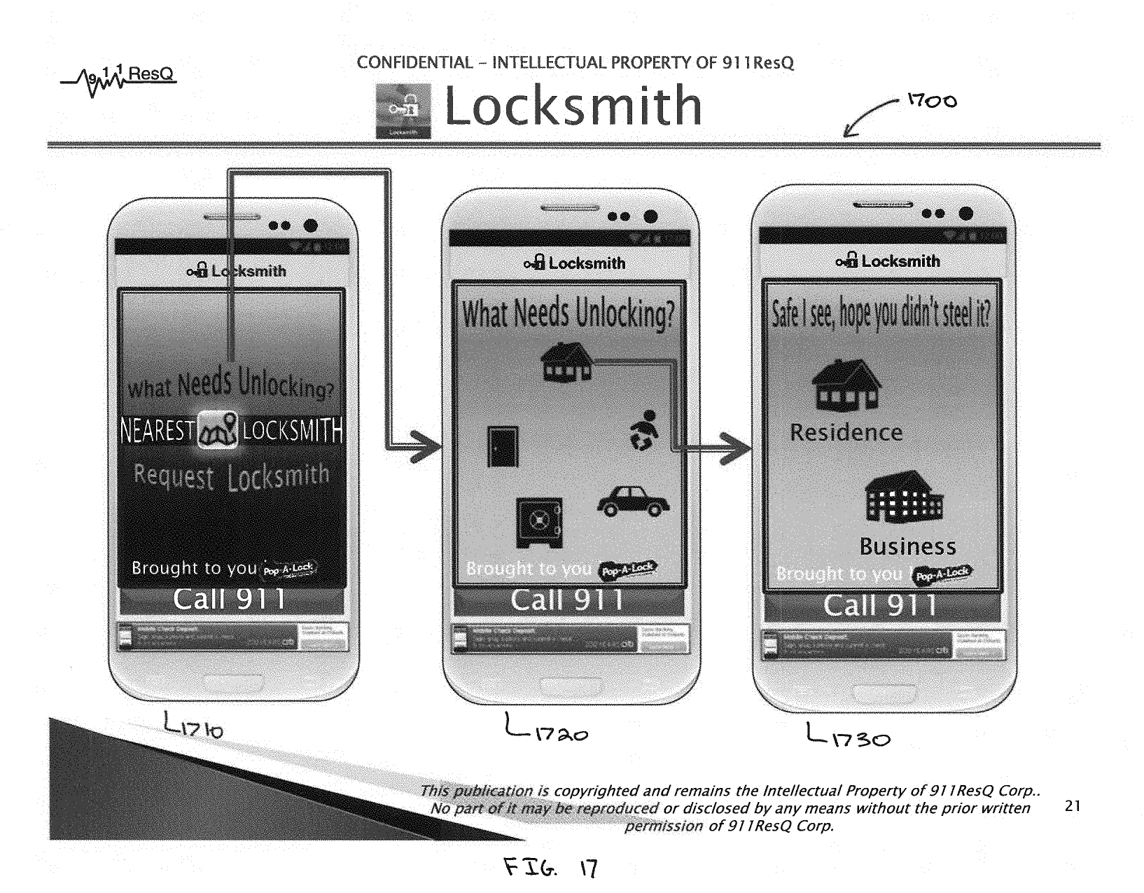

FIG. 17 shows display screens 1700 of locksmith service requests for a residence for a software application having service request functionality. For example, the software application having service request functionality may include features that are the same as or similar to those previously discussed. As shown, at step 1710, a display of shown that allows a user to provide details regarding the services desired for a locksmith to help ensure the proper locksmith and/or proper tools are brought by the locksmith to aid the user. For example, upon requesting the services of a locksmith by interfacing with the screen at step 1710, at step 1720, a display is shown to the user with possible equipment that the user desires to have unlocked. In the example shown, at step 1720, the user has selected a building. Operation then continues to step 1730 where the user is finally prompted for additional information regarding the building, namely whether it is a residential building (e.g., address) or a business building (e.g., address). In an alternative embodiment, additional and/or alternative options may be available for user selection or manipulation.

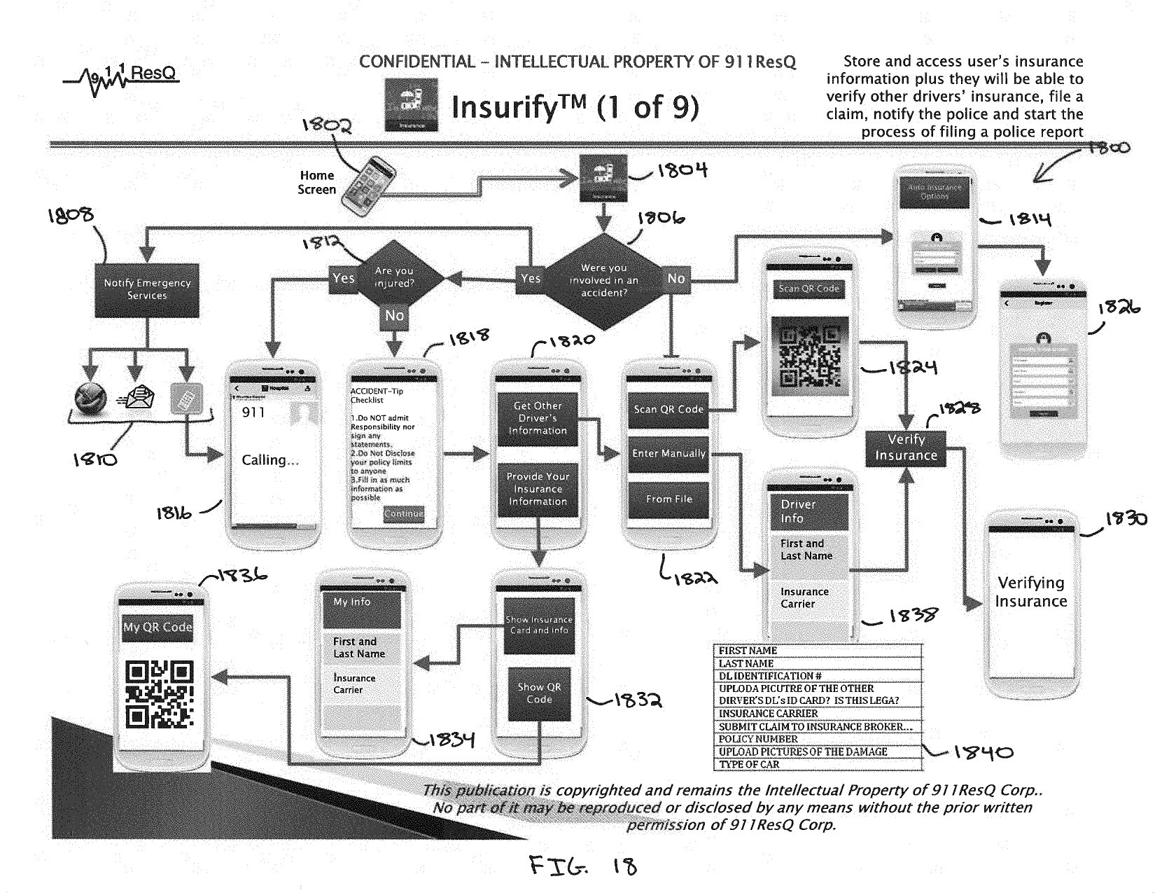

Turning next to FIG. 18, a flowchart 1800 is shown of insurance service requests for a software application having service request functionality. For example, the software application having service request functionality may include features that are the same as or similar to those previously discussed. As shown, at step 1802 a user of a software application may interface with the software application and at step 1804 select or choose insurance services. At step 1806, the software application prompts the user if they were involved in an accident. If the user responds with a Yes response, the user is prompted to clarify whether they wish to notify emergency services, via step 1808 or if they are injured 1812. If the user wishes to notify emergency services at step 1808, the user may be allowed to choose how they wish to communicate with the emergency service provider, for example via text, email, and/or phone 1810. For example, if the user wishes to use phone to communicate, operation may continue to step 1816 where the emergency service (e.g., 9-1-1) is dialed. Similarly, operation may continue to step 1816 and the emergency service dialed if the user responds with a Yes response at step 1812. However, if the user responds with a No response at step 1812, an accident checklist may be displayed to the user at step 1818, for example, to help instruct the user with advice or information about how to proceed now that an accident has occurred. Operation then continues to step 1820 where the user may choose between getting other driver information or providing their own insurance information.

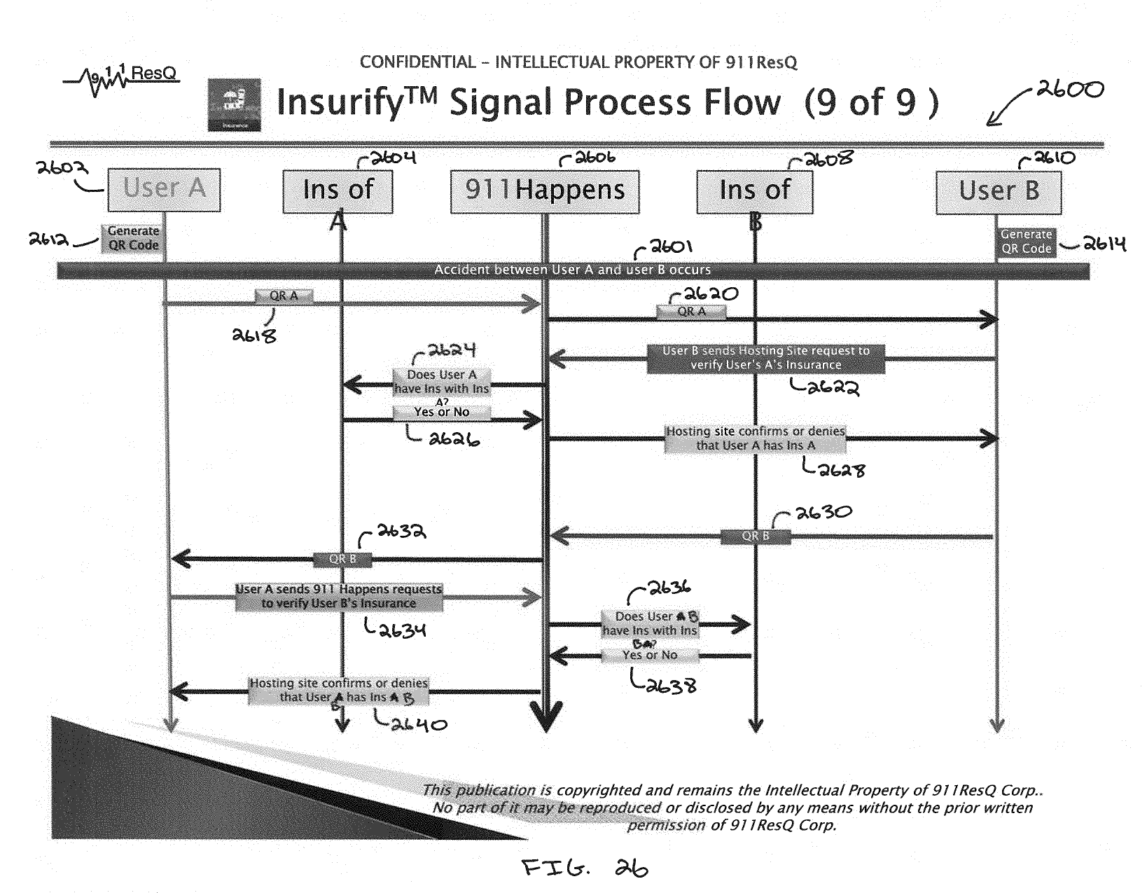

If the user desires to provide their own insurance information, operation continues to step 1832 where the user may choose between being shown their insurance card information or utilizing a QR code procedure. If the user responds with a desire to show insurance card information, operation continues to step 1834 where the user's insurance card and/or information is displayed by the software application. Thus, the user may then show this information to the other driver, to law enforcement officers, etc. as a convenient means of providing their insurance without requiring a hardcopy print-out of their insurance card. Alternatively, if the user responds with a desire to utilize a QR code procedure, operation continues to step 1836 where a QR code (or other electronically scannable image or code) is displayed by the software application. The QR code procedure may operate as discussed in greater detail here, for example, with reference to FIG. 26.

Turning back to step 1820, if the user responds that they wish to receive the other driver's information, operation continues to step 1822 where the user may choose to either scan a QR code, enter other driver insurance information manually, or load the other driver's insurance information from a file. Operation may also continue to step 1822 if the user responds with a No answer to the software application's query as to whether they were involved in an accident per step 1806. At step 1822, if the user responds by desiring to scan a QR code, operation continues to step 1824 and allows the user to scan a QR code (e.g., a QR code that is displayed upon a software application running on an electronic device of the other driver, as discussed in more detail, for example, on FIG. 26.).

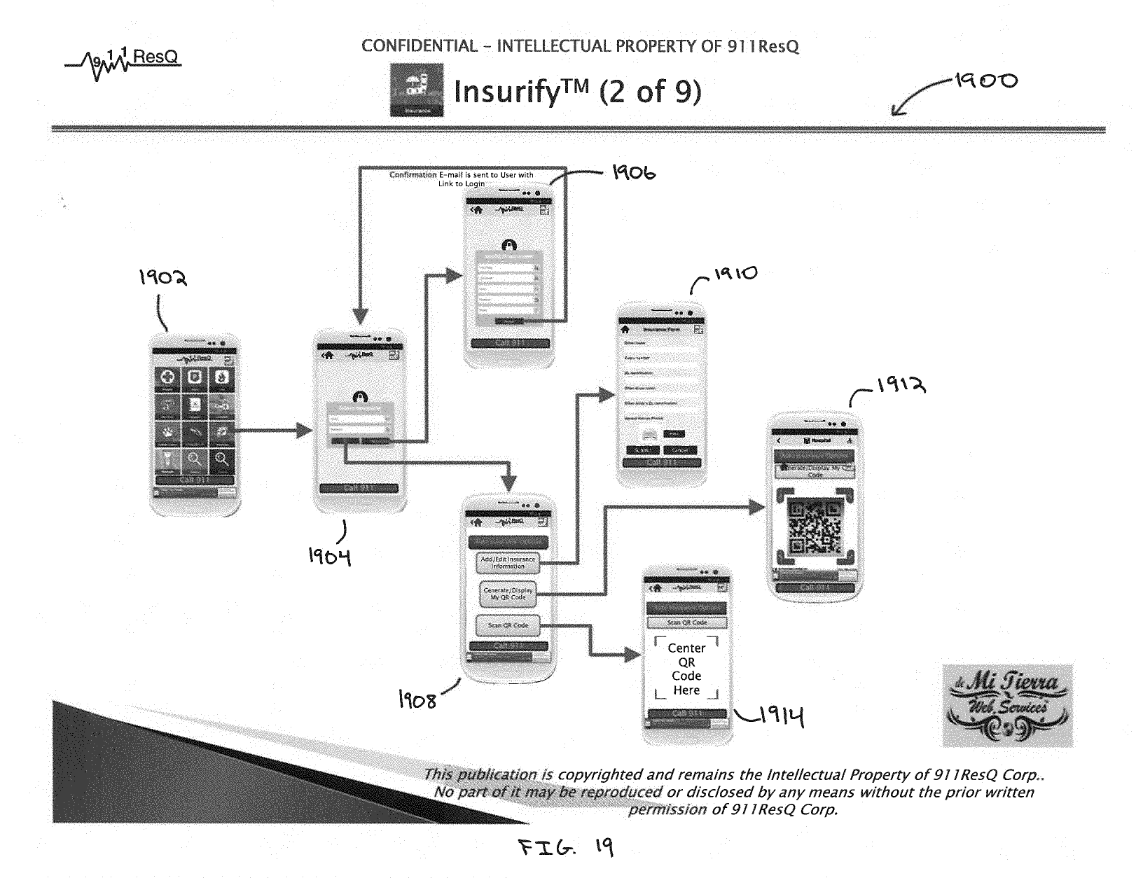

This scanned QR code is then verified at step 1828 (e.g., by contacting the insurance provider corresponding to the scanned QR code) and display screen 1830 is shown indicating that verification is in process. Likewise, if the user instead indicates at step 1822 that they wish to enter the other driver's insurance information manually and/or from a file, operation continues to step 1838 where the user may either input information using the software application and/or load a file containing information using the software application. Operation then continues again to steps 1828 and step 1830, as discussed above. If insurance is verified, or, in some alternative embodiments, even if insurance is not verified, operation may continue to step 1840 where various insurance information is shown on a display of the software application and further operation may occur based upon user response (e.g., submit a claim, upload pictures of vehicle damage, indicate bodily injuries, etc. as discussed in greater detail herein). FIGS. 19-26 illustrate a variety of example flowcharts and/or display screens for requesting various insurance services and may work in conjunction or relation with one or more steps discussed above for FIG. 18.

FIG. 19 shows a flowchart 1900 of insurance service requests for a software application having service request functionality. For example, the software application having service request functionality may include features that are the same as or similar to those previously discussed. As shown, at step 1902 a user of a software application may interface with the software application and select or choose insurance services. At step 1904, the user may be presented with a login and/or registration screen where they may enter a username and/or password (e.g., or other personal identifier). If a user does not have a previously registered account, the user may choose to register an account and operation continues to step 1906 where the user fills in information about themselves and/or their insurance carrier and/or policy. Upon completion and submittal, a confirmation (e.g., text, email, etc.) may be sent to the user and/or displayed by the software application and operation returns to step 1904. The user may then login with this registered information.

Upon login, operation continues to step 1908 where the user may choose to add/edit insurance information, generate/display a QR code for their insurance, or scan another's QR code (e.g., the same as or similar to the previous discussion). For example, if the user chooses to add/edit insurance information, operation continues to step 1910 that allows for further user input. If the user chooses to generate/display a QR code, operation continues to step 1912 where such code is displayed. If the user chooses to scan another's QR code, operation continues to step 1914 where the user may be permitted to scan another driver's QR code.

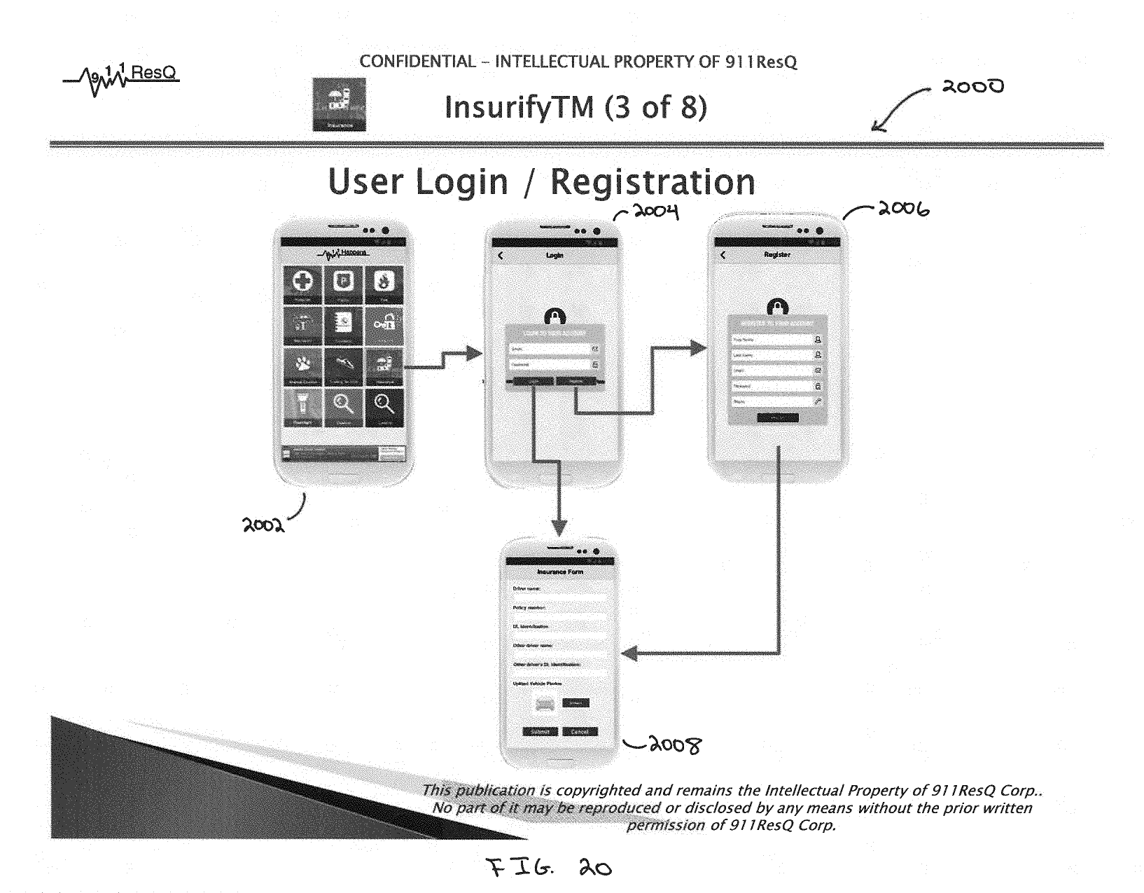

FIG. 20 shows a flowchart 2000 of insurance service requests (e.g., a login and/or registration process, the same as or similar to that previously discussed for FIG. 19) for a software application having service request functionality. For example, the software application having service request functionality may include features that are the same as or similar to those previously discussed. As shown, at step 2002 a user of a software application may interface with the software application and select or choose insurance services. Operation then continues to step 2004 which provides the user with a login/registration screen. If the user chooses to register, operation continues to step 2006 where personal registration information may be received (e.g., first and last name, email address, phone number, desired password, etc.). Upon successful registration and/or upon choosing to login rather than register at step 2004, operation continues to step 2008 where a user may enter further information identifying their insurance information.

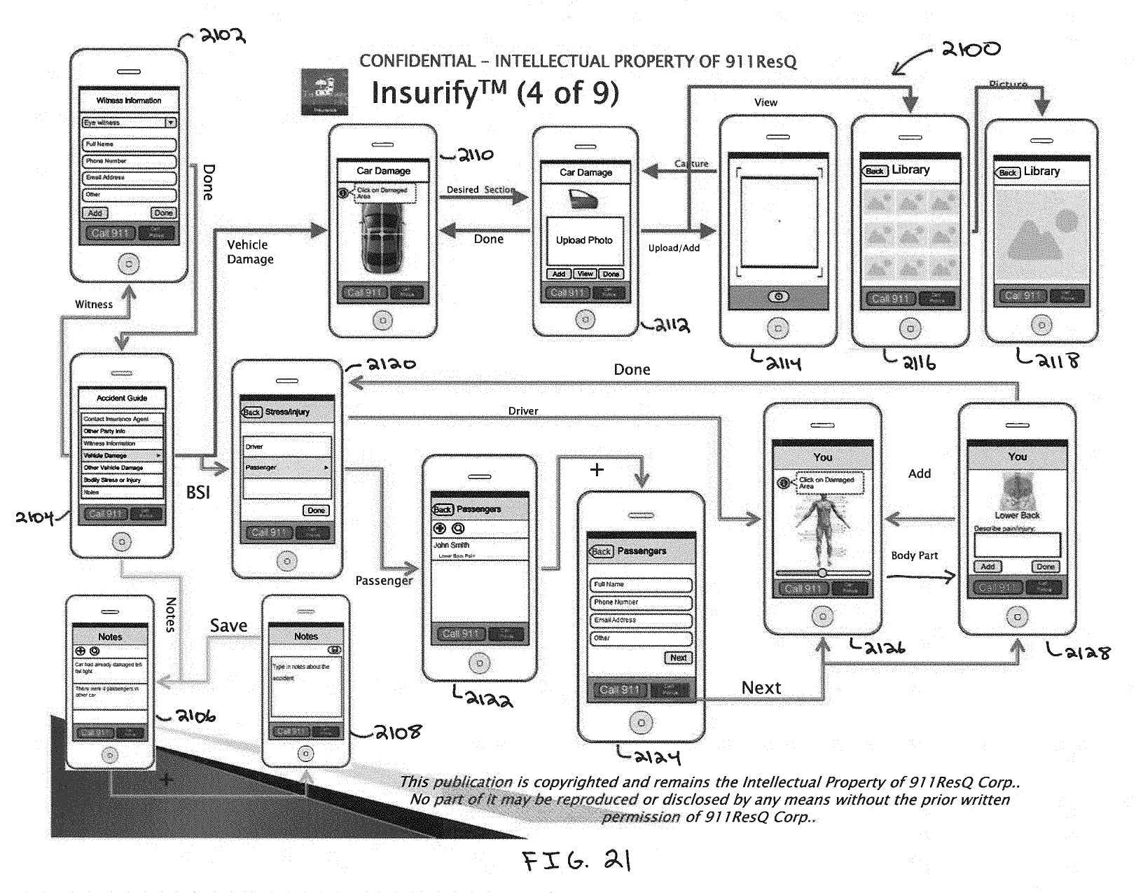

FIG. 21 shows a flowchart 2100 of insurance service requests for a software application having service request functionality. For example, the software application having service request functionality may include features that are the same as or similar to those previously discussed. As shown, at step 2101, once a car, vehicle, or other insurance coverable accident has occurred, a user of the software application may fill out one or more forms to add witness information for those individuals that witnessed the accident. If more than one witness was present, additional witnesses may be added. The witness information may include the type of witness (e.g., eye witness, after-accident occurred witness, passenger, etc.), their name, contact information, other notes, etc. Once the witness information is filled out, operation may continue to step 2104 which displays a screen of possible options for the user.

If the user chooses to add any notes about the crash (e.g., by interfacing with a user-interface element of the display of the software application at step 2104, operation may continue to step 2106 where the user can add and/or view notes or comments. If the user chooses to add a new note, operation continues to step 2108 where the new note may be entered by the user and then saved by the user such that operation returns to step 2106. Alternatively, at step 2104, if the user chooses to provide vehicle damage or bodily injury information regarding the accident, operation may continue to step 2110 or 2120, respectively.

Turning first to step 2110, vehicle damage may be identified by the user, for example, by clicking upon a damaged area of a displayed vehicle to choose a corresponding section of the vehicle that was damaged in the accident. Operation then continues to step 2112 where the user may upload and/or take a photograph of the actual damage that occurred to the vehicle. For example, uploading a picture may be performed by allowing the user to select amongst one or more saved pictures, at steps 2116 and 2118, which are stored in a memory accessible by the software application. Taking or capturing a photograph, at step 2114, may open up a camera application that allows a user to subsequently take a photograph of the damaged vehicle component.

If, instead of vehicle damage, the user chose to provide information at bodily injury at step 2104, operation continues to step 2120 where the user may choose which individual is desired for disclosing injury information (e.g., passenger, driver, pet, child in rear seat, etc.). For example, if the user chooses to disclose driver injury information, operation continues to step 2126 where a display of a human body may be shown and the user permitted to select a portion of the body. Operation may then continue to step 2128 where the user can describe and/or provide photographs that correspond to the injury or body part selected at step 2126. Such operation may continue until all of the injured body parts have corresponding description and/or photographs. Going back to step 2122, if the user instead, for example, chooses to disclose passenger information, operation continues to step 2122 where the user can view and/or add passenger information, such as name, contact information, date of birth, etc.) by progressing to step 2124 in order to add any of a number of passengers. The user may also be permitted to provide bodily injury information for any or all of the passengers disclosed utilizing a same or similar process as previously discussed above for steps 2126 and/or 2128.

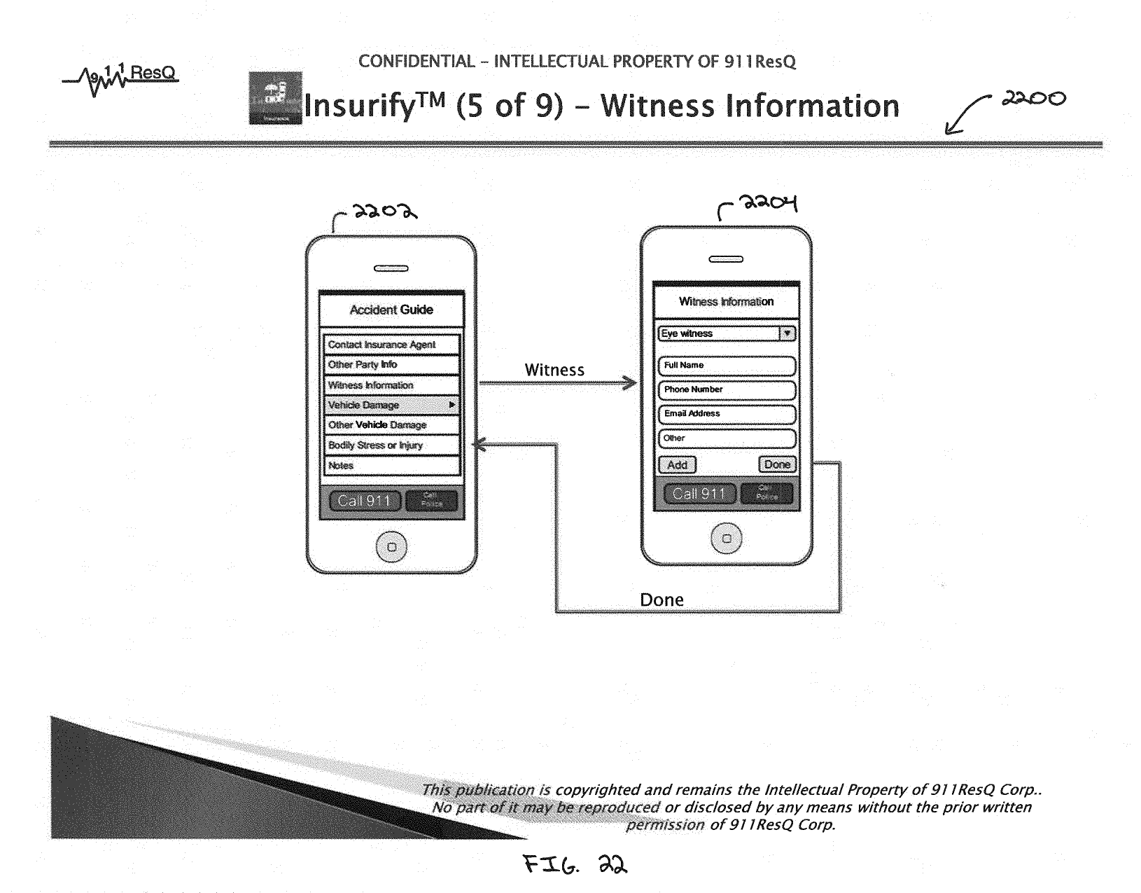

FIG. 22 shows a flowchart 2200 of insurance service requests (e.g., witness information) for a software application having service request functionality. For example, the software application having service request functionality may include features that are the same as or similar to those previously discussed, for example, steps 2102 and/or 2104 of FIG. 21. As previously mentioned, witnesses to an accident may have information about them entered and saved for a given accident in the software application. For example, at step 2202, a user may choose to add one or more witnesses and their corresponding information via step 2204 after an accident has occurred. One completed, operation may return to step 2202 where the user can choose among other options, discussed in more detail in other figures.

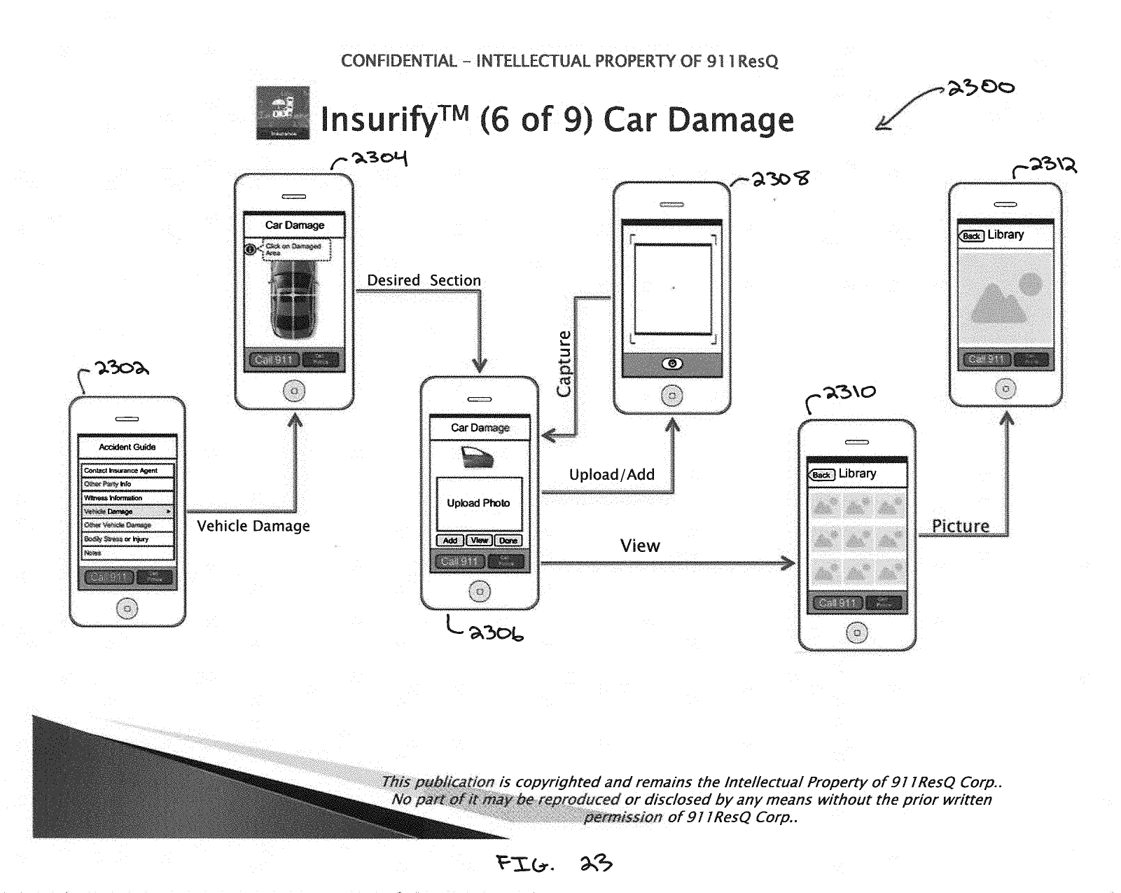

FIG. 23 shows a flowchart 2300 of insurance service requests (e.g., vehicle damage information) for a software application having service request functionality. For example, the software application having service request functionality may include features that are the same as or similar to those previously discussed, for example, steps 2110-2118 of FIG. 21. For example, a user may choose to enter vehicle damage via step 2302, identify damaged areas of a vehicle via step 2304, and upload newly captured photos or previously taken photos of the damaged area of the vehicle via steps 2306-2312.

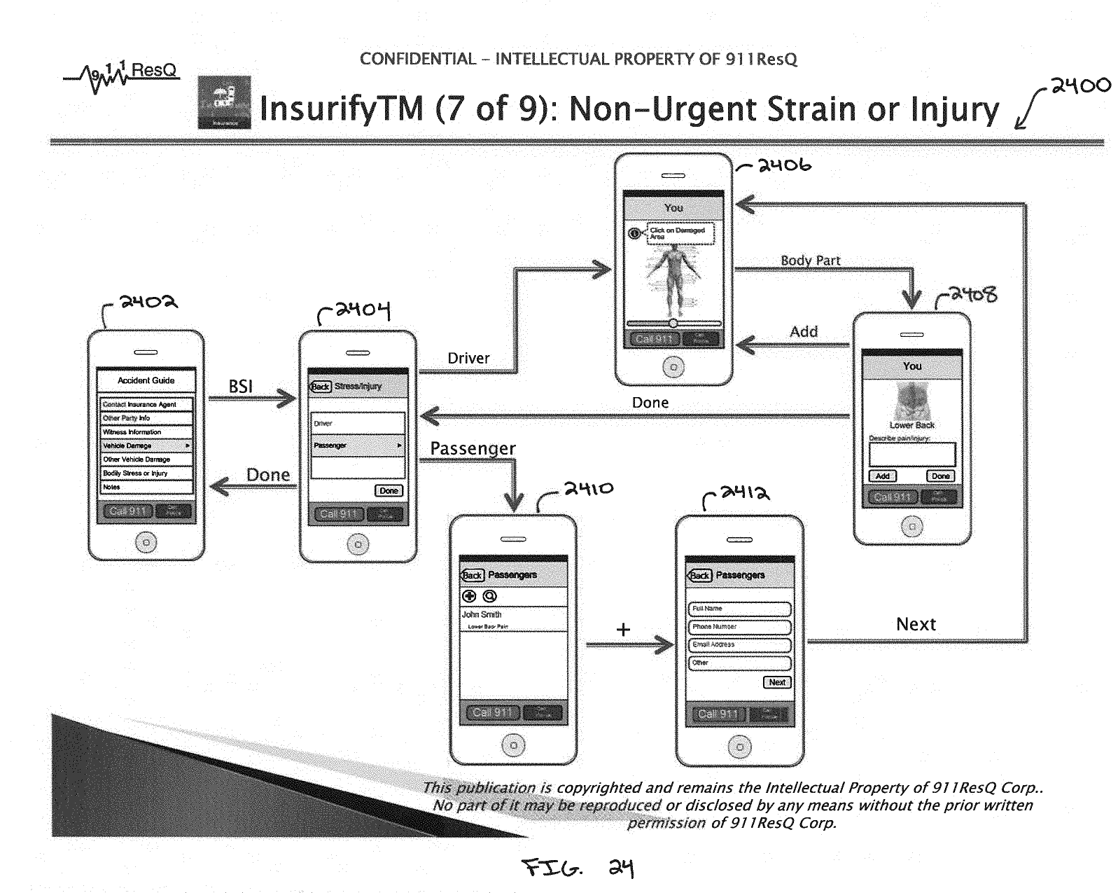

FIG. 24 shows a flowchart 2400 of insurance service requests (e.g., bodily injury information) for a software application having service request functionality. For example, the software application having service request functionality may include features that are the same as or similar to those previously discussed, for example, steps 2120-2128 of FIG. 21. For example, a user may choose to enter bodily injury damage via step 2402, identify whether a driver or passenger sustained injuries via step 2404, and identify who those individuals are and what bodily areas sustained damage via steps 2406-2412.

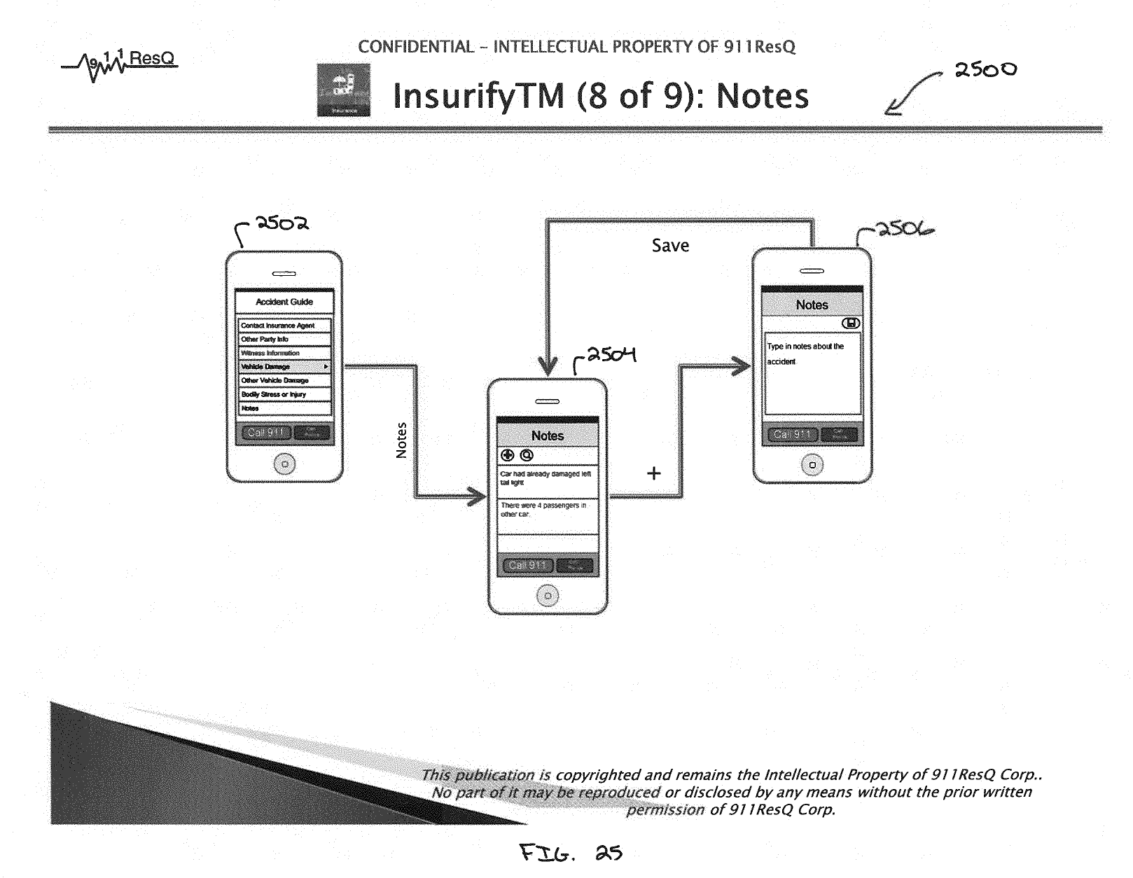

FIG. 25 shows a flowchart 2500 of insurance service requests (e.g., additional notes information) for a software application having service request functionality. For example, the software application having service request functionality may include features that are the same as or similar to those previously discussed, for example, steps 2104-2108 of FIG. 21. For example, a user may choose to enter additional notes regarding an accident via step 2502 and view previously entered notes and/or add new notes via steps 2504-2506.

FIG. 26 shows a process flow 2600 of insurance service requests (e.g., QR code process or procedure) for a software application having service request functionality. For example, the software application having service request functionality may include features that are the same as or similar to those previously discussed. For example, after a vehicle accident as occurred, one or both parties to the accident may desire to exchange insurance information. The process flow 2600 shown in FIG. 26 is one exemplary procedure that may allow for such exchange using a software application.

As shown, User A 2602, having Insurance of A 2604 and User B 2610 having Insurance of B 2608 may be using a software application that includes or provides an interface 2606 to help determine, verify, or exchange their respective insurance information. The software application may provide for the generation of a QR code (or other scannable image or code) 2612 for user A and the generation of a QR code (or other scannable image or code) 2614 for user B. If an accident 2601 occurs between User A 2602 and User B 2610 the software application may be configured to allow for exchange of insurance information between User A 2602 and user B 2612.

Starting first with User A 2602, the software application may be configured to transmit 2618 QR Code A from User A 2602 to a system or computer included or interfaceable with the software application. This QR code is communicated 2620 to User B 2610 and User B 2610 requests 2622 a verification of User A 2602 insurance. Via communication 2624 (e.g., contacting a system or database corresponding or associated with information of Insurance of A 2604, it is determined or verified whether User A 2602 has a valid insurance with Insurance A 2604 and a confirmation of such is communicated in return 2626. This information is then communicated 2628 back to User B.

Likewise, turning to User B 2604, the software application may be configured to transmit 2630 QR Code B from User B 26′0 to a system or computer included or interfaceable with the software application. This QR code is communicated 2632 to User A 2602 and User A 2602 requests 2634 a verification of User B 2610 insurance. Via communication 2636 (e.g., contacting a system or database corresponding or associated with information of Insurance of B 2608, it is determined or verified whether User B 2610 has a valid insurance with Insurance B 2608 and a confirmation of such is communicated in return 2638. This information is then communicated 2640 back to User A. In this fashion, both parties can receive verification of the other's insurance coverage via software applications running on their respective electronic devices via the sharing of QR codes or other indicia representative of each user.

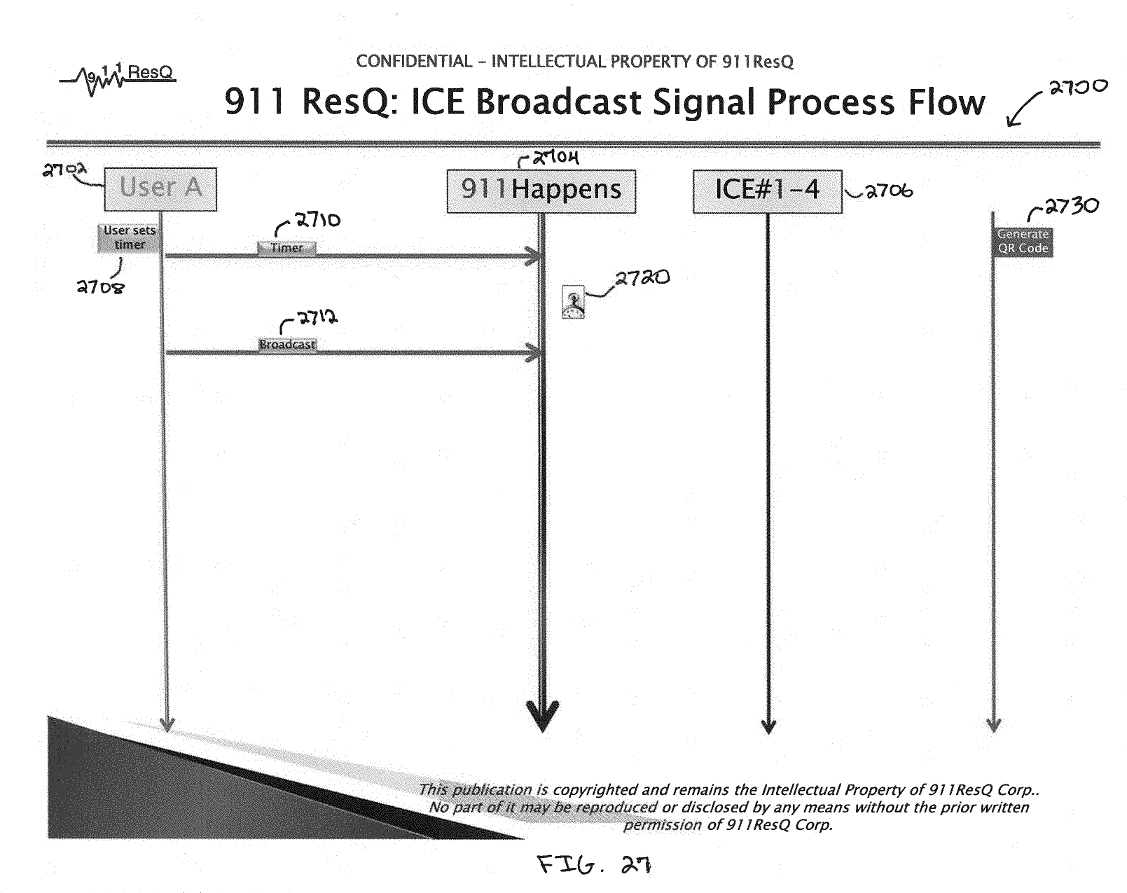

FIG. 27 shows process flow 2700 for “In Case of Emergency” requests for a software application having service request functionality. For example, the software application having service request functionality may include features that are the same as or similar to those previously discussed. As shown, FIG. 27 shows a User A 2702 and a system 2704 included or interfaceable with the software application that is capable of broadcast functionalities in the case of an emergency. For example, a user may be allowed to define a timer that controls how often (e.g., at an increased frequency) the mobile device of User A sends or responds to location requests from system 2704. In such a situation, a mobile device used by User A 2702 may send its location (e.g., to a nearby cell tower in the case of a cell phone) at a higher frequency than normal. The cell tower may transmit some or all of this information (e.g., GPS, cell tower coordinates or data, instrumentation locations, etc.) to another system (e.g., the system 2704). Various communication methods (e.g., SMS, MMS, NFC, Bluetooth, Wi-Fi, etc.) may be utilized to help ensure mobile device location is being regularly reported to the system 2704. In certain embodiments, a variety of calculation methods for minimizing error potential in determining the location of the mobile device may be used. The system 2704 may monitor and/or log the incoming location data for the mobile device and communicate and/or interface all or some of the information for display in a list or upon a map (e.g., as texts using latitude and/or longitude values or data.).

As shown in FIG. 27, User A 2702 defines the timer value 2708 and then initiates 2710 the timer with the system 2704 (e.g., by specifying that an emergency situation may be occurring via interfacing with a user interface element of the software application). A timer 2720 (e.g., having the defined value 2708) begins ticking down and upon each timer tick down/reset, location information corresponding to User A 2702 is broadcast 2712 to the system 2704. This location information may be sent automatically by the mobile device of User A 2702 due to the software application and/or the mobile device of User A 2702 may respond with location information due to pings from the system 2704 that occur at the timer 2720 tick down/reset. In certain embodiments, pings from the system 2704 may increase in frequency if no adequate response is received from the mobile device of User A 2702. Upon surpassing a threshold of pings without an adequate response received back, the system 2704 will begin broadcasting that an emergency is occurring. This emergency broadcast may include various information that may be of use to aid User A 2702, such as Phone ID information, date/time/location information, police and fire department contact information for any of a number (e.g., three) departments closest or more appropriate to the last known location (e.g., latitude/longitude) of the mobile device of User A 2702.

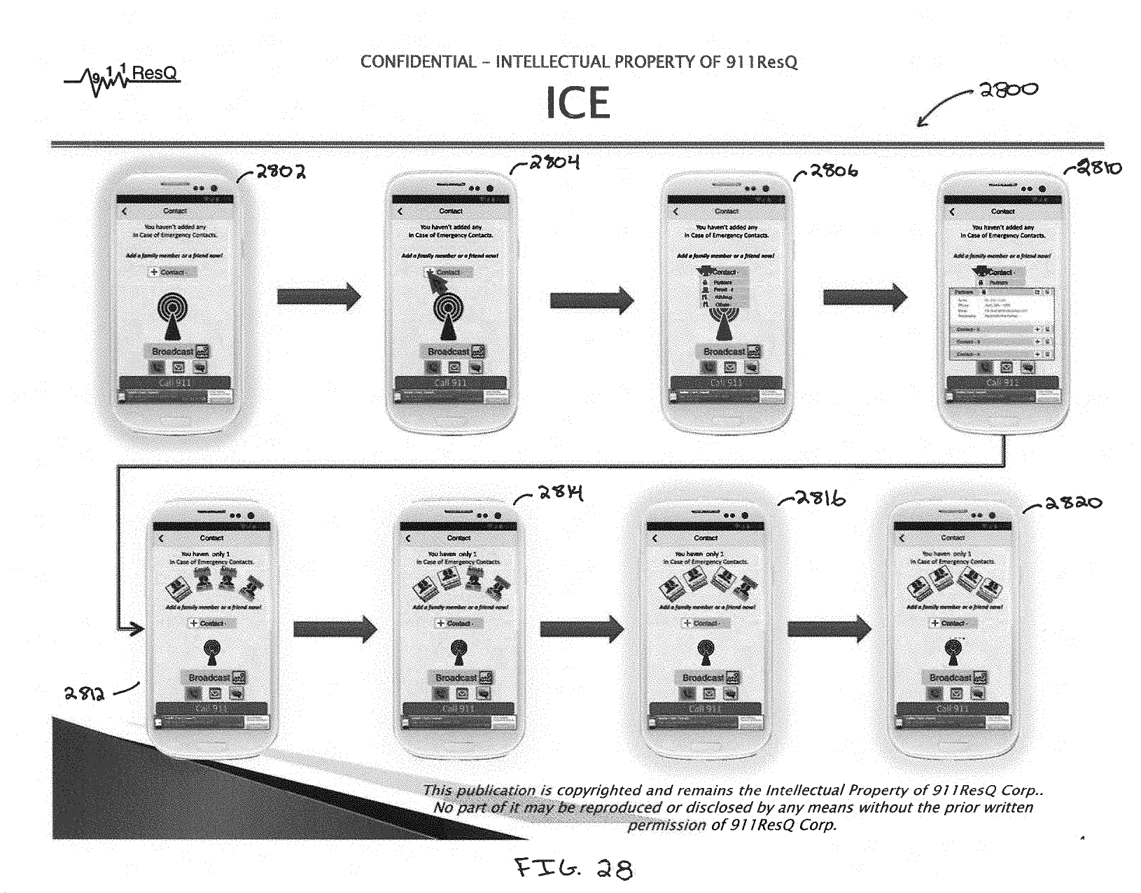

This broadcast may be sent to one or more emergency contacts 2706 (e.g., as discussed in greater detail, for example, in FIG. 28). In addition, a QR code or other indicia of User A 2730 may also have been generated and available or displayed for other individuals who may encounter User A during the emergency to scan and obtain information (e.g., insurance information, address or contact information, etc.) that may be of help in aiding User A 2702. In certain embodiments, additional or alternative information may be sent or broadcast during the emergency situation, such as a distress message (e.g., pre-set or user definable) via SMS/MMS, email, phone, etc.

Finally, FIG. 28 shows a flowchart 2800 of “In Case of Emergency” requests for a software application having service request functionality. For example, the software application having service request functionality may include features that are the same as or similar to those previously discussed. Emergency contacts (e.g., as discussed for FIG. 27) may be configurable by a user. For example, as shown, the software application may initially allow for any of a number of possible (e.g., four) emergency contacts. At step 2802 no contacts have been defined for a given user so a user may choose to add, at step 2804, a new emergency contact. At step 2806, information about this contact (e.g., whether they are a parent, partner, sibling, etc.) of the user can be selected and at step 2810, information (e.g., name, phone number, email address, etc.) may be configured to the contact. Steps 2812-2820 illustrate that additional emergency contacts may be setup, all of some of them receiving broadcast information in the case of an emergency, for example, as previously discussed for FIG. 27.

The previously discussed mobile or software applications may include features and/or operation different from those stated in the exemplary embodiments detailed above. Features and/or operation in one embodiment may also or additionally be included with features and/or operation of a separately discussed embodiment. Moreover, features may be added, removed, or executed with different operative flow from the exemplary embodiments detailed above. For example, flashlight functionality may be provided in certain embodiments of a software application that, upon selection by a user or in certain automatic circumstances, enables a light (e.g., always on, strobing, etc.) upon the electronic device of the user. In some embodiments, this light may be configured to flash standardized or recognized codes or signals (e.g., Morse Code or an S.O.S. signal). Further, in certain embodiments, messages, either pre-defined or user-customized, may be converted and flashed in Morse Code or another recognized code. In still another example of an additional feature that may be present in certain embodiments, a list of nationwide and/or worldwide reference numbers may be provided for display (e.g., Poison Control, Suicide Prevention, Homeland Security, etc.).

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A method of providing service request functionality to a user, the method comprising the steps of:
providing a mobile application configured to be executed by a processor of a mobile device;
determining, using the processor, a type of service desired by the user;
determining, using the processor, a geographic position of the mobile device;
determining, using the processor, an appropriate service provider to service the type of service desired by the user based on the geographic position of the mobile device;
interfacing, using the processor, with a system associated with the service provider; and
communicating to the user, using the processor, that the service provider will be servicing the type of service desired by the user.

2. A mobile application providing a service request functionality for a user comprising:
computer-readable instructions configured to be executed by a processor of a mobile device, the instructions configured to
determine, using the processor, a type of service desired by the user,
determine, using the processor, a geographic position of the mobile device,
interface, using the processor, with a system associated with the service provider, and
communicate to the user, using the processor, that the service provider will be servicing the type of service desired by the user.
